(19) United States
(12) Patent Application Publication
(10) Pub. No.: US 2017/0096597 A1
(43) Pub. Date: Apr. 6, 2017

(54) FRICTION REDUCTION ENHANCEMENT

(71) Applicant: Halliburton Energy Services, Inc., Houston, TX (US)

(72) Inventors: Yuntao Thomas Hu, The Woodlands, TX (US); HsinChen Chung, Houston, TX (US); Chandra Sekhar Palla-Venkata, Conroe, TX (US)

(73) Assignee: Halliburton Energy Services, Inc., Houston, TX (US)

(21) Appl. No.: 15/126,961

(22) PCT Filed: May 7, 2014
(86) PCT No.: PCT/US2014/037141

§ 371 Date: Sep. 16, 2016

(51) Int. Cl. C09K 8/68; C09K 8/035; E21B 43/26; C09K 8/72; C09K 8/42; C09K 8/88; C09K 8/60

(52) U.S. Cl. CPC C09K 8/68; C09K 8/882; C09K 8/035; C09K 8/602; C09K 8/725; C09K 8/42; E21B 43/26; C09K 2208/28

(57) ABSTRACT

Various embodiments disclosed relate to compositions for subterranean treatment including a friction-reducing polymer and a surfactant. In various embodiments, the present invention provides a method including obtaining or providing a composition including a friction reducing polymer and a surfactant. The method also includes placing the composition in the subterranean formation.

### BACKGROUND OF THE INVENTION

During the drilling, completion, and stimulation of subterranean wells, treatment fluids are pumped through wellbores and tubular structures (e.g., pipes, coiled tubing, etc.). A considerable amount of energy may be lost due to turbulence in the treatment fluid during pumping. As a result of these energy losses, additional horsepower may be needed to achieve the desired treatment. Excessive turbulence can damage wellbores and subterranean formations. To reduce damage and energy losses, fluid friction-reducers can be included in these treatment fluids. Fluid friction-reducers are chemical additives that alter fluid rheological properties to reduce friction created within a fluid as it flows through tubulars or other flowpaths. Generally, polymer-based fluid friction-reducers reduce or delay induced turbulence during flow and thereby reduce friction forces. Most ionic friction-reducer polymers are salt intolerant, and lose effectiveness in salt water (e.g., NaCl or KCl).

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

FIG. 3 illustrates the friction reduction of samples of partially hydrolyzed acrylamide friction-reducer in Ellenberger brine having various concentrations of the surfactant sodium dodecyl sulfate, in accordance with various embodiments.

FIG. 4 illustrates the friction reduction of samples of ampholyte terpolymer friction-reducer in Ellenberger brine having various concentrations of the surfactant cetyltrimethylammonium bromide, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing 3 or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

In various embodiments, the present invention provides a method of treating a subterranean formation. The method includes obtaining or providing a composition that includes a friction-reducing polymer and a surfactant. The method includes placing the composition in a subterranean formation.

In various embodiments, the present invention provides a method of treating a subterranean formation, the method including obtaining or providing a composition. About 0.001 wt % to about 80 wt % of the composition is a friction-reducing polymer. The friction reducing polymer is at least one of polymer (1) and polymer (2). Polymer (1) is a polymer including about Z¹ mol % of an ethylene repeating unit including a —C(O)NHR¹ group and including about N¹ mol % of an ethylene repeating unit including a —C(O)R² group. At each occurrence, R¹ is independently a substituted or unsubstituted (C₅-C₅₀)hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration. The variable Z¹ is about 0% to about 50%, N¹ is about 50% to about 100%, and Z¹+N¹ is about 100%. Polymer (2) is an ampholyte polymer including an ethylene repeating unit including a —C(O)NH₂ group, an ethylene repeating unit including an —S(O)₂OR¹¹ group, and an ethylene repeating unit including an —N⁺R¹²₃X⁻ group. At each occurrence, R¹¹ is independently selected from the group consisting of —H and a counterion. At each occurrence, R¹² is independently substituted or unsubstituted (C₁-C₂₀)hydrocarbyl. At each occurrence, X⁻ is independently a counterion. About 0.0001 wt % to about 20 wt % of the composition can be a surfactant. The surfactant is (a), (b), or (c), wherein (a) is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate; (b) is a (C₅-C₅₀)hydrocarbyltri((C₁-C₅₀)hydrocarbyl)ammonium salt, wherein each (C₅-C₅₀)hydrocarbyl is independently selected; and (c) is a combination of (a) and (b). The method also includes placing the composition in a subterranean formation. In some embodiments, about 50 wt % to about 99.999 wt % of the composition can be a brine having a total dissolved solids level of about 100,000 ppm to about 500,000 ppm.

In various embodiments, the present invention provides a method of treating a subterranean formation, the method including obtaining or providing a composition. About 0.001 wt % to about 80 wt % of the composition is a friction-reducing polymer. The friction-reducing polymer is at least one of polymer (1) and polymer (2). Polymer (1) is a polymer including repeating units having the structure:

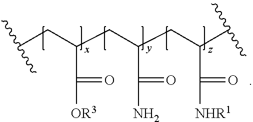

At each occurrence, R¹ is independently C₅-C₅₀ alkyl. At each occurrence, R² is independently selected from the group consisting of —NH₂ and —OR³. At each occurrence, R³ is independently selected from the group consisting of —H and a counterion selected from the group consisting of Na⁺, K⁺, Li⁺, NH₄⁺, and Mg²⁺. The repeating units are in a block, alternate, or random configuration, and each repeating unit is independently in the orientation shown or in the opposite orientation. The quantity x/(x+y+z) is about 0% to about 100%, the quantity y/(x+y+z) is about 0% to about 100%, the quantity z/(x+y+z) is about 0% to about 50%, and x+y is greater than zero. Polymer (2) is a polymer including repeating units having the structure:

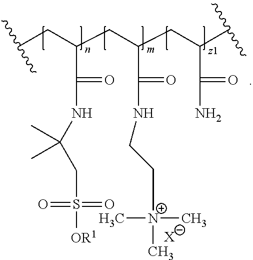

At each occurrence, R¹¹ is independently selected from the group consisting of —H and a counterion. The repeating units are in a block, alternate, or random configuration, and each repeating unit is independently in the orientation shown or in the opposite orientation. Polymer (2) has a molecular weight of about 100,000 g/mol to about 20,000,000 g/mol. Polymer (2) has about 30 wt % to about 50 wt % of the ethylene repeating unit including the —C(O)NH₂ group, about 5 wt % to about 15 wt % of the ethylene repeating unit including the —S(O)₂OR¹¹ group, and about 40 wt % to about 60 wt % of the ethylene repeating unit including the —N⁺R¹²₃X⁻ group. About 0.0001 wt % to about 20 wt % of the composition is a surfactant that is at least one of a dodecyl sulfate salt and a cetyltrimethylammonium salt. About 50 wt % to about 99.999 wt % of the composition is a brine having a total dissolved solids level of about 100,000 ppm to about 500,000 ppm. The method also includes placing the composition in a subterranean formation.

In various embodiments, the present invention provides system. The system includes a composition including a friction-reducing polymer and a surfactant. The system includes a subterranean formation including the composition therein.

In various embodiments, the present invention provides a composition for treatment of a subterranean formation. About 0.001 wt % to about 80 wt % of the composition is a friction-reducing polymer. The friction reducing polymer is at least one of polymer (1) and polymer (2). Polymer (1) is a polymer including about Z¹ mol % of an ethylene repeating unit including a —C(O)NHR¹ group and including about N¹ mol % of an ethylene repeating unit including a —C(O)R² group. At each occurrence, R¹ is independently a substituted or unsubstituted (C₅-C₅₀)hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration. The variable Z¹ is about 0% to about 50%, N¹ is about 50% to about 100%, and Z¹+N¹ is about 100%. Polymer (2) is an ampholyte polymer including an ethylene repeating unit including a —C(O)NH₂ group, an ethylene repeating unit including an —S(O)₂OR¹¹ group, and an ethylene repeating unit including an —N⁺R¹²₃X⁻ group. At each occurrence, R¹¹ is independently selected from the group consisting of —H and a counterion. At each occurrence, R¹² is independently substituted or unsubstituted (C₁-C₂₀)hydrocarbyl. At each occurrence, X⁻ is independently a counterion. About 0.0001 wt % to about 20 wt % of the composition can be a surfactant. The surfactant is (a), (b), or (c), wherein (a) is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate; (b) is a (C₅-C₅₀)hydrocarbyltri((C₁-C₅₀)hydrocarbyl)ammonium salt, wherein each (C₅-C₅₀)hydrocarbyl is independently selected; and (c) is a combination of (a) and (b). In some embodiments, about 50 wt % to about 99.999 wt % of the composition can be a brine having a total dissolved solids level of about 100,000 ppm to about 500,000 ppm.

In various embodiments, the present invention provides a method of preparing a composition for treatment of a subterranean formation. The method includes forming a composition including a friction-reducing polymer and a surfactant.

In various embodiments, the present composition and method can have certain advantages over other compositions and methods for reducing friction during treatment of a subterranean formation, at least some of which are unexpected. For example, unexpectedly, in various embodiments the addition of a surfactant to a polymer friction-reducer results in better friction reduction performance, such as more friction reduction for a given concentration of the friction-reducing polymer, such as in salt water or water having a higher total dissolved solids level.

In some embodiments, a smaller amount of the composition can be effective for friction reduction than would be needed from other friction-reducing compositions to obtain a corresponding reduction in friction. In some embodiments, the composition can be more effective for friction reduction in salt solutions than other compositions. In some embodiments, a smaller amount of the composition can be effective for friction reduction in a salt solution than would be needed from other friction-reducing compositions that are more salt-sensitive to obtain a corresponding reduction in friction. In some embodiments, contrasting with other friction-reducing compositions, the composition can have provide greater friction reduction in salt solutions than low salinity solutions or aqueous solutions free of salts. In various embodiments, for the amount of friction reduction provided, the composition can be less expensive than other salt-tolerant friction-reducers. In various embodiments, for the amount of friction reduction provided, the composition can be easier to prepare than other friction-reducing compositions.

Unexpectedly, in various embodiments, the addition of a surfactant to a polymer friction-reducer results in better viscosification of an aqueous solution, such as more viscosification for a given concentration of the friction-reducing polymer, such as in salt water or water having a higher total dissolved solids level. In some embodiments, a smaller amount of the composition can be effective for viscosification than would be needed from other viscosifying compositions to obtain a corresponding increase in viscosity. In some embodiments, the composition can provide a greater viscosity increase in salt solutions than other compositions. In some embodiments, a smaller amount of the composition can be effective for viscosification in a salt solution than would be needed from other viscosifying compositions that are more salt-sensitive to obtain a corresponding increase in viscosity. In some embodiments, contrasting with other viscosifying compositions, the composition can provide a greater viscosity increase in salt solutions than low salinity solutions or aqueous solutions free of salts.

### Method of Treating a Subterranean Formation.

Environmental concerns and government regulations can call for subterranean treatment fluids that perform well in water having high total dissolved solids levels, such in as certain produced waters. In various embodiments, the addition of a small amount of a surfactant can significantly enhance the friction reduction performance of a friction-reducing polymer, such as in salt water.

In various embodiments, the present invention provides a method of treating a subterranean formation. The method includes obtaining or providing a composition including a friction-reducing polymer and a surfactant. As used herein “a friction-reducing polymer” and “a surfactant” refers to at least one friction-reducing polymer and at least one surfactant, respectively, unless otherwise indicated. The obtaining or providing of the composition can occur at any suitable time and at any suitable location. The obtaining or providing of the composition can occur above the surface. The obtaining or providing of the composition can occur in the subterranean formation (e.g., downhole). The method also includes placing the composition in a subterranean formation. The placing of the composition in the subterranean formation can include contacting the composition and any suitable part of the subterranean formation, or contacting the composition and a subterranean material, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include pumping the composition into a subterranean formation for any suitable purpose.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). In some embodiments, the composition is a fracturing fluid or includes a fracturing fluid. The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

In some embodiments, in addition to the friction-reducing polymer and the surfactant, the composition can include an aqueous liquid. The method can further include mixing the aqueous liquid with the composition. The mixing can occur at any suitable time and at any suitable location, such as above surface or in the subterranean formation. The aqueous liquid can be any suitable aqueous liquid, such as at least one of water, brine, produced water, flowback water, brackish water, and sea water. In some embodiments, the aqueous liquid can include at least one of an aqueous drilling fluid, aqueous fracturing fluid, aqueous diverting fluid, and an aqueous fluid loss control fluid. In some embodiments, the aqueous liquid can be the aqueous phase of an emulsion (e.g., the composition can include an emulsion having as the aqueous phase the aqueous liquid).

The composition can include any suitable proportion of the aqueous liquid, such that the composition can be used as described herein. For example, about 0.0001 wt % to 99.999,9 wt % of the composition can be the aqueous liquid, or about 0.01 wt % to about 99.99 wt %, about 0.1 wt % to about 99.9 wt %, or about 20 wt % to about 90 wt %, or about 0.0001 wt % or less, or about 0.000001 wt %, 0.0001, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999 wt %, or about 99.999,9 wt % or more of the composition can be the aqueous liquid.

The aqueous liquid can be a salt water. The salt can be any one or more suitable salts, such as at least one of NaBr, CaCl₂, CaBr₂, ZnBr₂, KCl, NaCl, a magnesium salt, a bromide salt, a formate salt, an acetate salt, and a nitrate salt. The friction-reducing polymer and surfactant can provide effective friction reduction in aqueous solutions having various total dissolved solids levels, or having various ppm salt concentrations. The friction-reducing polymer and the surfactant can provide effective friction reduction of a salt water having any suitable total dissolved solids level (e.g., wherein the dissolved solids correspond to dissolved salts), such as about 1,000 mg/L to about 500,000 mg/L, about 1,000 mg/L to about 250,000 mg/L, or about 1,000 mg/L or less, or about 5,000 mg/L, 10,000, 15,000, 20,000, 25,000, 30,000, 40,000, 50,000, 75,000, 100,000, 125,000, 150,000, 175,000, 200,000, 225,000, 250,000, 300,000, 350,000, 400,000, 450,000, or about 500,000 mg/L or more. The friction-reducing polymer and surfactant can provide effective increased viscosity of a salt water having any suitable salt concentration, such as about 1,000 ppm to about 500,000 ppm, about 1,000 ppm to about 300,000 ppm, or about 1,000 ppm to about 150,000 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, 300,000, 350,000, 400,000, 450,000, or about 500,000 ppm or more. In some examples, the aqueous liquid can have a concentration of at least one of NaBr, CaCl₂, CaBr₂, ZnBr₂, KCl, and NaCl of about 0.1% w/v to about 20% w/v, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

In various embodiments, the surfactant can increase the friction reduction provided by the friction-reducing polymer, such as in salt water. In various embodiments, the composition is sufficient such that, as compared to a corresponding composition not including the surfactant, the composition including the surfactant provides about 1% to about 200% greater friction reduction, about 10% to about 100% greater friction reduction, about 20% to about 90% , or about 30% to 60% greater friction reduction, or about 10% greater friction reduction or less, or about 15% greater friction reduction, 20%, 22, 24, 26, 28, 30, 32, 34, 36, 38, 40, 42, 44, 46, 48, 50, 52, 54, 56, 58, 60, 65, 70, 75, 80, 85, 90, 95, 100, 110, 120, 130, 140, 150, 160, 170, 180, 190%, or about 200% greater friction reduction or more. The percent friction reduction can be determined as compared to the friction experienced by a corresponding solution not including the friction reducer. For example, the percent friction reduction can be measured as the pressure drop in a friction loop as compared to the pressure drop of a sample not including the friction-reducing polymer or the surfactant, wherein the percent friction reduction is measured between 1 minute and 10 days after the pumping through the loop begins, wherein the composition includes brine having a total dissolved solids level of about 1,000 ppm to about 500,000 ppm. For example, the percent friction reduction can be measured as the pressure drop in a ½ inch-diameter friction loop with a pumping rate of 10 gallons per minute as compared to the pressure drop of a sample not including the friction-reducing polymer or the surfactant, wherein the percent friction reduction is measured between 5 and 20 minutes after the pumping begins, wherein the composition includes about 0.01 wt % to about 10 wt % of the friction-reducing polymer and about 0.001 wt % to about 1 wt % of the surfactant, and wherein the composition includes about 89 wt % to about 99.999 wt % of brine having a total dissolved solids level of about 100,000 ppm to about 300,000 ppm.

### Friction-Reducing Polymer.

The composition can include one or more friction-reducing polymers. The friction-reducing polymers can be any suitable friction reducing polymers, such that the composition can be used as described herein. Any suitable proportion of the composition can be the one or more friction-reducing polymers, such that the composition can be used as described herein. For example, about 0.001 wt % to about 80 wt % of the composition can be the one or more friction-reducing polymers, about 0.01 wt % to about 10 wt %, about 0.01 wt % to about 5 wt %, about 0.1 wt % to about 2 wt %, or about 0.001 wt % or less, or about 0.01 wt %, 0.1, 1, 2, 3, 4, 5, 6, 7, 8, 9, 10, 12, 14, 16, 18, 20, 25, 30, 35, 40, 45, 50, 55, 60, 65, 70, 75, or about 80 wt % or more.

A wide variety of friction-reducing polymers can be suitable for use with various embodiments of the method. In certain embodiments, the friction-reducing polymer can be a synthetic polymer. In some embodiments, the friction-reducing polymer can be an anionic polymer (e.g., including acid groups or acid salt groups), a cationic polymer (e.g., including ammonium groups or other positively charged groups), or an amphiphilic polymer. In some embodiments, the ionic groups of the polymer can include counterions, such that the overall charge of the ionic groups is neutral, whereas in other embodiments, no counterion can be present for one or more ionic groups, such that the overall charge of the one or more ionic groups is not neutral.

One example of a suitable anionic friction-reducing polymer is a polymer including acrylamide and acrylic acid (e.g., a polymer derived from polymerization of a mixture that includes acrylamide and acrylic acid). The acrylamide and acrylic acid can be present in the polymer in any suitable concentration. An example of a suitable anionic friction-reducing polymer can include acrylamide in an amount in the range of about 5 wt % to about 95 wt % and acrylic acid in an amount in the range of about 5 wt % to about 95 wt %. Another example of a suitable anionic friction-reducing polymer can include acrylamide in an amount in the range of about 60 wt % to about 90 wt % and acrylic acid in an amount in the range of about 10 wt % to about 40 wt %. Another example of a suitable anionic friction-reducing polymer can include acrylamide in an amount in the range of about 80 wt % to about 90 wt % and acrylic acid in an amount in the range of about 10 wt % to about 20 wt %. Another example of a suitable anionic friction-reducing polymer can include acrylamide in an amount of about 85% by weight and acrylic acid in an amount of about 15% by weight. In some examples, one or more additional monomers can be included in an anionic friction-reducing polymer including acrylamide and acrylic acid, such as up to about 20% by weight of the polymer.

The friction-reducing polymer can be prepared by any suitable technique. For example, an anionic friction-reducing polymer including acrylamide and acrylic acid can be prepared through polymerization of acrylamide and acrylic acid or through hydrolysis of polyacrylamide (e.g., partially hydrolyzed polyacrylamide).

The friction-reducing polymers suitable for use in embodiments of the present invention can be used in any suitable form. For example, the friction-reducing polymers can be provided as emulsion polymers, solution polymers, or in dry form. In certain embodiments, the friction-reducing polymer can be provided in a concentrated polymer composition that includes the friction-reducing polymer, such as in a more concentrated form than in the final treatment fluid that is used in the subterranean treatment. In some embodiments, the friction-reducing polymer can be provided or used as an oil-external emulsion that includes the friction-reducing polymer dispersed in the continuous hydrocarbon phase (e.g., hydrocarbon solvents, etc.) or in the aqueous phase.

Suitable friction-reducing polymers can reduce energy losses due to turbulence within the treatment fluid. The molecular weight can be sufficient to provide a desired level of friction-reduction. For example, the molecular weight of suitable friction-reducing polymers can be at least about 2,500,000, such as determined using intrinsic viscosities. In certain embodiments, the molecular weight of suitable friction-reducing polymers can be in the range of from about 7,500,000 to about 20,000,000. Certain friction-reducing polymers having molecular weights outside the listed range can still provide some degree of friction-reduction.

In some embodiments, the friction reducing polymer can be an ionic friction-reducing polymer. In some embodiments, the friction reducing polymer can include at least one monomer derived from a compound selected from the group consisting of a carboxylic acid-substituted (C₂-C₂₀)alkene, a (C₂-C₂₀)alkylene oxide, a ((C₁-C₂₀)hydrocarbyl (C₁-C₂₀)alkanoic acid ester)-substituted (C₂-C₂₀)alkene, a ((C₁-C₂₀)alkanoic acid salt)-substituted (C₂-C₂₀)alkene, a (C₁-C₂₀)alkanoyloxy(C₁-C₂₀)hydrocarbyl tri(C₁-C₂₀)hydrocarbylammonium salt, a (substituted or unsubstituted amide)-substituted (C₂-C₂₀)alkene, a sulfonic acid-, sulfonic acid (C₁-C₂₀)hydrocarbyl ester-, or sulfonic acid salt-substituted (C₂-C₂₀)alkene, a (sulfonic acid (C₁-C₂₀)hydrocarbyl ester-, or sulfonic acid salt-substituted (C₁-C₂₀)hydrocarbylamido)-substituted (C₂-C₂₀)alkene, an N-(C₂-C₂₀)alkenyl (C₂-C₂₀)alkanoic acid amide, and a mono-, di-, tri-, or tetra-(C₂-C₂₀)alkenyl-substituted ammonium salt, wherein the ammonium group is further substituted or unsubstituted, wherein each hydrocarbyl, alkene, alkylene, alkanoic, and alkanoyl group is independently interrupted or terminated with 0, 1, 2, or 3 groups chosen from —O—, —NH—, and —S—, wherein each hydrocarbyl, alkene, alkylene, alkanoic, and alkanoyl group is independently further substituted or further unsubstituted. In some embodiments, the friction-reducing polymer includes at least one monomer derived from a compound selected from the group consisting of acrylamide, acrylic acid or a salt thereof, 2-acrylamido-2-methylpropane sulfonic acid or a salt thereof, N,N-dimethylacrylamide, vinyl sulfonic acid or a salt thereof, N-vinyl acetamide, N-vinyl formamide, itaconic acid or a salt thereof, methacrylic acid or a salt thereof, acrylic acid ester, methacrylic acid ester, diallyl dimethyl ammonium chloride, dimethylaminoethyl acrylate, acryloyloxy ethyl trimethyl ammonium chloride, ethylene oxide, and 2-(2-ethoxyethoxy)-ethyl acrylate.

The friction-reducing polymer can include about Z¹ mol % of an ethylene repeating unit including a —C(O)NHR¹ group and can include about N¹ mol % of an ethylene repeating unit including a —C(O)R² group. At each occurrence, R¹ can independently be a substituted or unsubstituted (C₅-C₅₀)hydrocarbyl. At each occurrence, R² can independently be selected from the group consisting of —NH₂ and —OR³, wherein at each occurrence, R³ is independently selected from the group consisting of —R¹, —H, and a counterion. The repeating units can be in block, alternate, or random configuration. The variable Z¹ can be about 0% to about 50%, N¹ can be about 50% to about 100%, and Z¹+N¹ can be about 100%. In some embodiments, the friction-reducing polymer is a terpolymer including about X¹ mol % of an ethylene repeating unit including a —C(O)OR³ group and including about Y¹ mol % of an ethylene repeating unit including a —C(O)NH₂ group, wherein the repeating units are in block, alternate, or random configuration, Z¹ is about 0% to about 50%, X¹ is about 0% to about 100%, Y¹ is about 0% to about 100%, and Z¹+X¹+Y¹ is about 100%.

In some embodiments, the friction-reducing polymer includes repeating units having the structure:

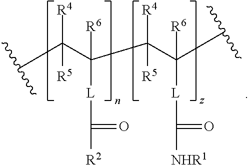

At each occurrence, R⁴, R⁵, and R^{b} can be independently selected from the group consisting of —H and a substituted or unsubstituted C₁-C₅ hydrocarbyl. At each occurrence L can be independently selected from the group consisting of a bond and a substituted or unsubstituted C₁-C₂₀ hydrocarbyl. The repeating units can be in a block, alternate, or random configuration, and each repeating unit is independently in the orientation shown or in the opposite orientation. For example, each monomer repeating unit at each occurrence can independently be stereoregular (e.g., tactic) with respect to adjacent repeating units, or can be stereoirregular (e.g., atactic) with respect to adjacent repeating units. The quantity n/(n+z) can be about 50% to about 100%, or about 75% to about 99.9%, or about 50% or less, or about 55%, 60, 65, 70, 75, 80, 85, 90, 95, 96, 97, 98, 99, 99.9, 99.99, or 99.999% or more. The quantity z/(n+z) can be about 0% to about 50%, or about 0.1% to about 25%, or about 0.001% or less, or about 0.01%, 0.1, 1, 2, 3, 4, 5, 10, 15, 20, 25, 30, 35, 40, 45, or about 50% or more. The variable n can be about 5,000 to about 5,000,000, or about 5,000 to about 2,000,000, or about 5,000 or less, or about 10,000, 20,000, 50,000, 100,000, 200,000, 250,000, 500,000, 750,000, 1,000,000, 1,250,000, 1,500,000, 1,750,000, 2,000,000, 3,000,000, 4,000,000, or about 5,000,000 or more. The variable z can be about 0 to about 1,000,000, or about 500 to about 600,000, or about 0, or about 1, 2, 3, 4, 5, 10, 15, 20, 25, 30, 35, 40, 45, 50, 60, 70, 80, 90, 100, 200, 300, 400, 500, 1,000, 10,000, 20,000, 25,000, 50,000, 100,000, 200,000, 300,000, 400,000, 500,000, 600,000, 700,000, 800,000, 900,000, or about 1,000,000 or more.

In some embodiments, the friction-reducing polymer includes repeating units having the structure:

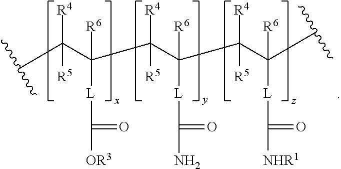

At each occurrence, R⁴, R⁵, and R⁶ can be independently selected from the group consisting of —H and a substituted or unsubstituted C₁-C₅ hydrocarbyl. At each occurrence, L can be independently selected from the group consisting of a bond and a substituted or unsubstituted C₁-C₂₀ hydrocarbyl. The repeating units can be in a block, alternate, or random configuration. Each repeating unit can be independently in the orientation shown or in the opposite orientation, and the quantity x+y=n. The quantity x/(x+y+z) can be about 0% to about 100%, or about 20% to about 40%, or about 5% or less, or about 10%, 15, 20, 25, 30, 35, 40, 45, 50, 55, 60, 65, 70, 75, 80, 85, 90, or about 95% or more. The quantity y/(x+y+z) can be about 0% to about 100%, about 0% to about 90%, or about 50% to about 80%, or about 40% or less, or about 45%, 50, 55, 60, 65, 70, 75, 80, 85, 90, or about 95% or more. The quantity x+y can be greater than zero, such as about 50%, 55, 60, 65, 70, 75, 80, 85, 90, 95, or 100%. The quantity z/(x+y+z) can be about 0% to about 50%, or about 0.1% to about 25%, or about 0.001% or less, or about 0.01%, 0.1, 1, 2, 3, 4, 5, 10, 15, 20, 25, 30, 35, 40, 45, or about 50% or more. In various embodiments, the repeating groups having degree of polymerization x, y, and z are the only repeating groups in the polymer, such that the mol % of the three repeating groups totals to 100%. The variable x can be about 0 to about 5,000,000, 300 to about 500,000, or about 1,000 to about 500,000, or about 0, 1, 2, 3, 4, 5, 10, 15, 20, 25, 50, 75, 100, 150, 200, 300, 400, 500, 1,000, 5,000, 10,000, 50,000, 100,000, 150,000, 200,000, 250,000, 300,000, 350,000, 400,000, 450,000, 500,000, 750,000, 1,000,000, 2,500,000, or about 5,000,000 or more. The variable y can be about 0 to about 5,000,000, about 1,000 to about 3,500,000, or about 1,000 or less, or about 0, 1, 2, 3, 4, 5, 10, 15, 20, 25, 50, 75, 100, 150, 200, 300, 400, 500, 1,000, 5,000, 10,000, 50,000, 100,000, 200,000, 250,000, 500,000, 1,000,000, 2,500,000, or about 5,000,000 or more. The variable z can be about 0 to about 1,000,000, about 300 to about 1,000,000, or about 0, 1, 2, 3, 4, 5, 10, 15, 20, 25, 50, 75, 100, 150, 200, 300, 400, 500, 1,000, 10,000, 20,000, 25,000, 50,000, 100,000, 200,000, 300,000, 400,000, 500,000, 600,000, 700,000, 800,000, 900,000, or about 1,000,000 or more.

In various embodiments, the friction-reducing polymer is a partially hydrolyzed acrylamide, having z=0, and having about 10 to about 50 mol % or about 20 to about 40 mol % hydrolyzed groups (e.g., acrylic acid or a salt thereof, such as a sodium salt) and having about 50 mol % to about 90 mol % or about 60 mol % to about 80 mol % unhydrolyzed acrylamide groups.

At each occurrence, R⁴, R⁵, and R⁶ can be independently selected from the group consisting of —H and a C₁-C₅ alkyl. At each occurrence, R⁴, R⁵, and R⁶ can be independently selected from the group consisting of —H and a C₁-C₃ alkyl. At each occurrence, R⁴, R⁵, and R⁶ can each be —H.

In some embodiments, at each occurrence, L is independently selected from the group consisting of a bond and C₁-C₂₀ hydrocarbyl. Each L connected directly to the C(O)OR³ group can be a bond (e.g., each C(O)OR³ can be directly bonded to the polymer backbone) and each L connected directly to the C(O)NH₂ or C(O)NHR¹ groups can be independently selected from a bond and C₁-C₂₀ hydrocarbyl. At each occurrence, L can be independently selected from the group consisting of a bond and C₁-C₅ alkyl. In some embodiments, at each occurrence, L can be a bond.

In some embodiments, at each occurrence, R¹ can be independently (C₅-C₅₀)hydrocarbyl. At each occurrence, R¹ can be independently C₆-C₂₅ hydrocarbyl. At each occurrence, R¹ can be independently C₁₄-C₁₈ hydrocarbyl. At each occurrence, R¹ can be independently C₆-C₂₅ alkyl.

At each occurrence, R³ can be independently selected from the group consisting of —R¹, —H, and a counterion. The counterion can be any suitable counterion. For example, the counterion can be sodium (Na⁺), potassium (K⁺), lithium (Li⁺), hydrogen (H⁺), zinc (Zn⁺), or ammonium (NH₄⁺). In some embodiments, the counterion can have a positive charge greater than +1, which can, in some embodiments, complex to multiple ionized groups, such as Ca²⁺, Mg²⁺, Zn²⁺ or Al³⁺. For example, the counterion can be selected from the group consisting of Na⁺, K⁺, Li⁺, NH₄⁺, and Mg²⁺. At each occurrence, R³ can be independently selected from the group consisting of —H and a counterion selected from the group consisting of Na⁺, K⁺, Li⁺, NH₄⁺, and Mg²⁺.

The friction-reducing polymer can have any suitable molecular weight. For example, the friction-reducing polymer can have a molecular weight of about 50,000 to about 100,000,000, about 5,000,000 to about 50,000,000, or about 50,000 or less, 100,000, 250,000, 500,000, 1,000,000, 2,500,000, 5,000,000, 10,000,000, 20,000,000, 25,000,000, 50,000,000, 75,000,000, or about 100,000,000 or more.

In some embodiments, the friction-reducing polymer includes repeating units having the structure:

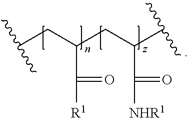

At each occurrence, R¹ can be independently C₅-C₅₀ alkyl. At each occurrence, R² can be independently selected from the group consisting of —NH₂ and —OR³. At each occurrence, R³ can be independently selected from the group consisting of —H and a counterion selected from the group consisting of Na⁺, K⁺, Li⁺, NH₄⁺, and Mg²⁺. The repeating units can be in a block, alternate, or random configuration. Each repeating unit can be independently in the orientation shown or in the opposite orientation. The variable n can be about 5,000 to about 5,000,000 and z can be about 0 to about 1,000,000.

In some embodiments, the friction-reducing polymer can include repeating units having the structure:

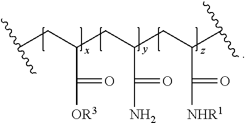

At each occurrence, R¹ can be independently C₅-C₅₀ alkyl. At each occurrence, R² can be independently selected from the group consisting of —NH₂ and —OR³. At each occurrence, R³ can be independently selected from the group consisting of —H and a counterion selected from the group consisting of Na⁺, K⁺, Li⁺, NH₄⁺, and Mg⁺. The repeating units can be in a block, alternate, or random configuration. Each repeating unit can be independently in the orientation shown or in the opposite orientation. The variable x can be about 0 to about 5,000,000, y can be about 0 to about 5,000,000, and z can be about 0 to about 1,000,000.

In various embodiments, the friction-reducing polymer can be an ampholyte polymer including an ethylene repeating unit including a —C(O)NH₂ group, an ethylene repeating unit including an —S(O)₂OR¹¹ group, and an ethylene repeating unit including an —N⁺R¹²₃X⁻ group. At each occurrence, R¹¹ can be independently selected from the group consisting of —H and a counterion. At each occurrence, R¹² can be independently substituted or unsubstituted (C₁-C₂₀)hydrocarbyl. At each occurrence, X⁻ can be independently a counterion.

The friction-reducing ampholyte polymer can have about Z^{wt} wt % of the ethylene repeating unit including the —C(O)NH₂ group, wherein Z^{wt} is any suitable wt %, such as about 10% to about 70%, about 30% to about 50%, or about 10% or less, or about 15%, 20, 25, 30, 31, 32, 33, 34, 35, 36, 37, 38, 39, 40, 41, 42, 43, 44, 45, 46, 47, 48, 49, 50, 55, 60, 65%, or about 70% or more. The friction-reducing ampholyte polymer can have about Z^{mol} mol % of the ethylene repeating unit including the —C(O)NH₂ group, wherein Z^{mol} is any suitable mol %, such as about 5% to about 50%, about 10% to about 25%, or about 5% or less, or about 10%, 11, 12, 13, 14, 15, 16, 17, 18, 19, 20, 21, 22, 23, 24, 25, 30, 35, 40, 45, or about 50% or more.

The friction-reducing ampholyte polymer can have about N^{wt} wt % of the ethylene repeating unit including the —S(O)₂OR¹ group, wherein N^{wt} wt % is any suitable wt %, such as about 1% to about 40%, 5% to about 15%, or about 1% or less, or about 5%, 6, 7, 8, 9, 10, 11, 12, 13, 14, 15, 20, 25, 30, 35, or about 40% or more. The friction-reducing ampholyte polymer can have about N^{mol} mol % of the ethylene repeating unit including the —S(O)₂OR¹ group, wherein N^{mol} mol % is any suitable mol %, such as about 1% to about 40%, 5% to about 20%, or about 1% or less, 5%, 6, 7, 8, 9, 10, 11, 12, 13, 14, 15, 16, 17, 18, 19, 20, 25, 30, 35, or about 40% or more.

The friction-reducing ampholyte polymer can have about M^{wt} wt % of the ethylene repeating unit including the —N⁺R²₃X⁻ group, wherein M^{wt} wt % is any suitable wt %, such as about 20% to about 80%, 40% to about 60%, or about 20% or less, 25%, 30, 35, 40, 41, 42, 43, 44, 45, 46, 47, 48, 49, 50, 51, 52, 53, 54, 55, 56, 57, 58, 59, 60, 65, 70, 75, or about 80% or more. The friction-reducing ampholyte polymer can have about M^{mol} mol % of the ethylene repeating unit including the —N⁺R²₃X⁻ group, wherein M^{mol} mol % is any suitable mol %, such as about 40% to about 90%, 55% to about 70%, or about 40% or less, 45, 50, 55, 56, 57, 58, 59, 60, 61, 62, 63, 64, 65, 66, 67, 68, 69, 70, 75, 80, 85, or about 90% or more.

In various embodiments, the friction-reducing ampholyte polymer is a terpolymer, e.g., Z^{wt}+N^{wt}+M^{wt} is about 100%, and Z^{mol}+N^{mol}+M^{mol} is about 100%.

The friction-reducing ampholyte polymer can have any suitable molecular weight, such as about 100,000 g/mol to about 20,000,000 g/mol, 2,000,000 g/mol to about 20,000,000 g/mol, about 5,000,000 g/mol to about 15,000,000 g/mol, or about 100,000 g/mol or less, or about 200,000 g/mol, 300,000, 400,000, 500,000, 750,000, 1,000,000, 2,000,000, 3,000,000, 4,000,000, 6,000,000, 8,000,000, 10,000,000, 12,000,000, 14,000,000, 16,000,000, 18,000,000, or about 20,000,000 g/mol or more.

In various embodiments, the friction-reducing ampholyte polymer includes repeating units having the structure:

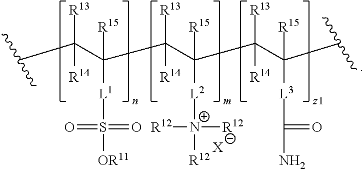

The repeating units are in a block, alternate, or random configuration, and each repeating unit is independently in the orientation shown or in the opposite orientation.

At each occurrence, R¹¹ can be independently selected from the group consisting of —H and a counterion. At each occurrence R¹¹ can be independently selected from the group consisting of —H, Na⁺, K⁺, Li⁺, NH₄⁺, Zn⁺, Ca²⁺, Zn²⁺, Al³⁺, and Mg⁺. At each occurrence, R¹¹ can be —H.

At each occurrence, R² can be independently substituted or unsubstituted (C₁-C₂₀)hydrocarbyl. At each occurrence R¹² can be independently (C₁-C₂₀)alkyl. At each occurrence R¹² can be independently (C₁-C₁₀) alkyl. At each occurrence R¹² can be independently selected from the group consisting of methyl, ethyl, propyl, butyl, and pentyl. At each occurrence, R¹² can be methyl.

At each occurrence, X⁻ can independently be a counterion. For example, the counterion can be a halide, such as fluoro, chloro, iodo, or bromo. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some embodiments, a counterion can have a negative charge greater than −1, which can in some embodiments complex to multiple ionized groups, such as oxide, sulfide, nitride, arsenate, phosphate, arsenite, hydrogen phosphate, sulfate, thio sulfate, sulfite, carbonate, chromate, dichromate, peroxide, or oxalate. At each occurrence, X⁻ can be Cl⁻.

At each occurrence R¹³, R¹⁴, and R¹⁵ can each independently be selected from the group consisting of —H and a substituted or unsubstituted C₁-C₅ hydrocarbyl. At each occurrence R¹³, R¹⁴, and R¹⁵ can be independently selected from the group consisting of —H and a C₁-C₅ alkyl. At each occurrence R¹³, R¹⁴, and R¹⁵ can be independently selected from the group consisting of —H and a C₁-C₃ alkyl (e.g., methyl, ethyl, or propyl). At each occurrence R¹³, R¹⁴, and R¹⁵ can be each —H.

At each occurrence L¹, L², and L³ can be each independently selected from the group consisting of a bond and a substituted or unsubstituted C₁-C₂₀ hydrocarbyl interrupted or terminated with 0, 1, 2, or 3 of at least one of —NR³—, —S—, and —O—.

At each occurrence L¹ can be independently selected from the group consisting of a bond and -(substituted or unsubstituted C₁-C₂₀ hydrocarbyl)-NR³-(substituted or unsubstituted C₁-C₂₀ hydrocarbyl)-. At each occurrence L¹ can be independently —C(O)—NH-(substituted or unsubstituted C₁-C₁₉ hydrocarbyl)-. At each occurrence L¹ can be independently —C(O)—NH—(C₁-C₅ hydrocarbyl)-. The variable L¹ can be —C(O)—NH—CH(CH₃)₂—CH₂—.

At each occurrence, L² can be independently selected from the group consisting of —O—(C₁-C₂₀)hydrocarbyl- and —NR¹³—(C₁-C₂₀)hydrocarbyl-. At each occurrence, L² can be independently selected from —O—(C₁-C₁₀)alkyl- and —NH—(C₁-C₁₀)alkyl-. At each occurrence, L² can be independently selected from —O—CH₂—CH₂— and —NH—CH₂—CH₂.

At each occurrence L³ can be independently selected from the group consisting of a bond and C₁-C₂₀ hydrocarbyl. At each occurrence L³ can be independently selected from the group consisting of a bond and C₁-C₅ alkyl. At each occurrence L³ can be a bond.

The variable n can be about 4 to about 40,000, about 90 to about 40,000, about 450 to about 14,500, or about 4 or less, or about 5, 6, 7, 8, 9, 10, 15, 20, 25, 30, 40, 50, 60, 70, 80, 90, 100, 200, 250, 500, 750, 1,000, 1,250, 1,500, 1,750, 2,000, 2,250, 2,500, 3,000, 3,500, 4,000, 4,500, 5,000, 6,000, 7,000, 8,000, 9,000, 10,000, 11,000, 12,000, 13,000, 14,000, 15,000, 20,000, 25,000, 30,000, 35,000, or about 40,000 or more.

The variable m can be about 100 to about 83,000, about 2,000 to about 83,000, about 4,000 to about 62,000, or about 100 or less, or about 200, 300, 400, 500, 750, 1,000, 1,500, 2,000, 3,000, 4,000, 7,500, 10,000, 15,000, 20,000, 25,000, 30,000, 35,000, 40,000, 45,000, 50,000, 55,000, 60,000, 65,000, 70,000, 75,000, 80,000, or about 85,000 or more.

The variable z1 can be about 125 to about 200,000, about 2,500 to about 200,000, about 8,500 to about 140,000, or about 125 or less, 150, 175, 200, 250, 300, 400, 500, 750, 1,000, 1,500, 2,000, 2,500, 3,000, 4,000, 5,000, 10,000, 15,000, 20,000, 25,000, 30,000, 40,000, 50,000, 60,000, 70,000, 80,000, 90,000, 100,000, 110,000, 120,000, 130,000, 140,000, 150,000, 160,000, 170,000, 180,000, 190,000, or about 200,000 or more.

In some embodiments, the friction-reducing ampholyte polymer can be derived from acrylamide, acryloyloxyethyl trimethylammonium chloride, and 2-acrylamido-2-methylpropane sulfonic acid (AMPS) or a salt thereof, and includes repeating units having the structure:

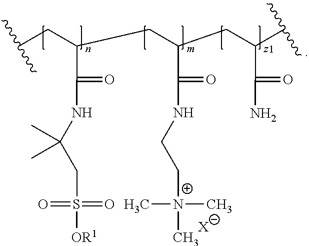

In some embodiments, the friction-reducing ampholyte polymer can be derived from acrylamide, methacrylamidopropyl trimethylammonium chloride, and 2-acrylamido-2-methylpropane sulfonic acid (AMPS) or a salt thereof, and includes repeating units having the structure:

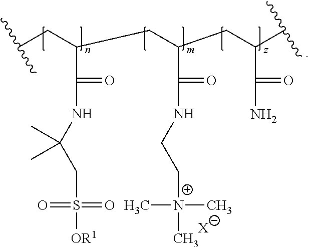

The repeating units are in a block, alternate, or random configuration, and each repeating unit is independently in the orientation shown or in the opposite orientation. In some embodiments, at each occurrence, R¹¹ can be independently selected from the group consisting of —H and a counterion. The polymer can have a molecular weight of about 100,000 g/mol to about 20,000,000 g/mol. The polymer can have about 30 wt % to about 50 wt % of the ethylene repeating unit including the —C(O)NH₂ group, about 5 wt % to about 15 wt % of the ethylene repeating unit including the —S(O)₂OR¹¹ group, and about 40 wt % to about 60 wt % of the ethylene repeating unit including the —N⁺R¹²₃X⁻ group.

In various embodiments, the composition can further include a complexing agent. In some embodiments, ions present in the surrounding solution (e.g., in the brine solution or downhole fluid) can undesirably interact with the friction-reducing polymer to reduce its effectiveness. However, the use of one or more complexing agents to control ions in the water can improve the performance of the friction-reducing polymers, such as by forming complexes with the ions to prevent undesirable interactions between the ions and the friction-reducing polymer. The complexing agent can be present in an amount effective to improve the friction-reducing performance of the friction-reducing polymer in water containing ions. For example, the complexing agent can be present in a mole ratio of the complexing agent to an anionic monomer of the polymer of about 10:1 to about 1:7, about 5:1 to about 1:4, or about 3:1 to about 1:2. In one embodiment, the complexing agent can be added in an amount of about 1 pound of complexing agent to about 1 pound of the friction-reducing polymer (dry weight of the polymer), about 1 pound of complexing agent to about 10 pounds of the friction-reducing polymer, or about 1 pound of complexing agent to 15 pounds of the friction-reducing polymer. In some embodiments, the complexing agent can be included in the composition in an amount of from about 50% to about 200% of the normality of the ion (e.g., calcium ion) concentration in the water. In one embodiment, the complexing agent can be included at equinormality to the ion concentration.

Examples of suitable complexing agents can include carbonates, phosphates, pyrophosphates, orthophosphates, citric acid, gluconic acid, glucoheptanoic acid, ethylenediaminetetraacetic acid (EDTA), nitrilotriacetic acid (NTA), salts thereof, and combinations thereof. For example, the sodium salt of EDTA, the sodium salt of NTA, and the sodium salt of citric acid can be suitable complexing agents. Examples of suitable phosphates include sodium phosphates. Examples of suitable carbonates include sodium carbonate and potassium carbonate.

### Surfactant.

The composition can include one or more surfactants. The surfactant can be any suitable surfactant, such that the composition can be used as described herein. The surfactant can form any suitable proportion of the composition, such that the composition can be used as described herein. For example, about 0.0001 wt % to about 20 wt % of the composition can be the one or more surfactants, about 0.001 wt % to about 1 wt %, or about 0.0001 wt % or less, or about 0.001 wt %, 0.005, 0.01, 0.02, 0.04, 0.06, 0.08, 0.1, 0.2, 0.3, 0.4, 0.5, 0.6, 0.8, 1, 2, 3, 4, 5, 6, 7, 8, 9, 10, 11, 12, 13, 14, 15, 16, 17, 18, 19, or about 20 wt % or more.

In some embodiments, the surfactant is at least one of a cationic surfactant, an anionic surfactant, and a non-ionic surfactant. In some embodiments, the ionic groups of the surfactant can include counterions, such that the overall charge of the ionic groups is neutral, whereas in other embodiments, no counterion can be present for one or more ionic groups, such that the overall charge of the one or more ionic groups is not neutral.

In one example, the surfactant can be a non-ionic surfactant. Examples of non-ionic surfactants can include polyoxyethylene alkyl ethers, polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene glycol modified polysiloxane surfactants, and mixtures, copolymers or reaction products thereof. In one example, the surfactant is polyglycol-modified trimethylsilylated silicate surfactant. Examples of suitable non-ionic surfactants can include, but are not limited to, condensates of ethylene oxide with long chain fatty alcohols or fatty acids such as a (C₁₂₋₁₆)alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, fatty amine oxides, polyoxyalkylene alkyl ethers such as polyethylene glycol long chain alkyl ether, polyoxyalkylene sorbitan ethers, polyoxyalkylene alkoxylate esters, polyoxyalkylene alkylphenol ethers, ethylene glycol propylene glycol copolymers and alkylpolysaccharides, polymeric surfactants such as polyvinyl alcohol (PVA) and polyvinylmethylether. In certain embodiments, the surfactant is a polyoxyethylene fatty alcohol or mixture of polyoxyethylene fatty alcohols. In other embodiments, the surfactant is an aqueous dispersion of a polyoxyethylene fatty alcohol or mixture of polyoxyethylene fatty alcohols. In some examples, suitable non-ionic surfactants can include at least one of an alkyl polyglycoside, a sorbitan ester, a methyl glucoside ester, an amine ethoxylate, a diamine ethoxylate, a polyglycerol ester, an alkyl ethoxylate, an alcohol that has been at least one of polypropoxylated and polyethoxylated, any derivative thereof, or any combination thereof.

Examples of suitable anionic surfactants can include, but are not limited to, alkyl sulphates such as lauryl sulphate, polymers such as acrylates/C₁₀₋₃₀ alkyl acrylate crosspolymer alkylbenzenesulfonic acids and salts such as hexylbenzenesulfonic acid, octylbenzenesulfonic acid, decylbenzenesulfonic acid, dodecylbenzenesulfonic acid, cetylbenzenesulfonic acid and myristylbenzenesulfonic acid; the sulphate esters of monoalkyl polyoxyethylene ethers; alkylnapthylsulfonic acid; alkali metal sulfoccinates, sulfonated glyceryl esters of fatty acids such as sulfonated monoglycerides of coconut oil acids, salts of sulfonated monovalent alcohol esters, amides of amino sulfonic acids, sulfonated products of fatty acid nitriles, sulfonated aromatic hydrocarbons, condensation products of naphthalene sulfonic acids with formaldehyde, sodium octahydroanthracene sulfonate, alkali metal alkyl sulphates, ester sulphates, and alkarylsulfonates. Anionic surfactants can include alkali metal soaps of higher fatty acids, alkylaryl sulfonates such as sodium dodecyl benzene sulfonate, long chain fatty alcohol sulfates, olefin sulfates and olefin sulfonates, sulfated monoglycerides, sulfated esters, sulfonated ethoxylated alcohols, sulfosuccinates, alkane sulfonates, phosphate esters, alkyl isethionates, alkyl taurates, and alkyl sarcosinates.

Suitable cationic surfactants can include at least one of an arginine methyl ester, an alkanolamine, an alkylenediamide, an alkyl ester sulfonate, an alkyl ether sulfonate, an alkyl ether sulfate, an alkali metal alkyl sulfate, an alkyl or alkylaryl sulfonate, a sulfosuccinate, an alkyl or alkylaryl disulfonate, an alkyl disulfate, an alcohol polypropoxylated or polyethoxylated sulfates, a taurate, an amine oxide, an alkylamine oxide, an ethoxylated amide, an alkoxylated fatty acid, an alkoxylated alcohol, an ethoxylated fatty amine, an ethoxylated alkyl amine, a betaine, a modified betaine, an alkylamidobetaine, a quaternary ammonium compound, any derivative thereof, and any combination thereof. Examples of suitable cationic surfactants can include quaternary ammonium hydroxides such as octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide and coco trimethyl ammonium hydroxide as well as corresponding salts of these materials, fatty amines and fatty acid amides and their derivatives, basic pyridinium compounds, and quaternary ammonium bases of benzimidazolines and poly(ethoxylated/propoxylated) amines.

In some embodiments, the surfactant can be selected from Tergitol™ 15-s-3, Tergitol™ 15-s-40, sorbitan monooleate, polylycol-modified trimethsilylated silicate, polyglycol-modified siloxanes, polyglycol-modified silicas, ethoxylated quaternary ammonium salt solutions, cetyltrimethylammonium chloride or bromide solutions, an ethoxylated nonyl phenol phosphate ester, and a (C₁₂-C₂₂)alkyl phosphonate. In some examples, the surfactant can be a sulfonate methyl ester , a hydrolyzed keratin, a polyoxyethylene sorbitan monopalmitate, a polyoxyethylene sorbitan monostearate, a polyoxyethylene sorbitan monooleate, a linear alcohol alkoxylate, an alkyl ether sulfate, dodecylbenzene sulfonic acid, a linear nonyl-phenol, dioxane, ethylene oxide, polyethylene glycol, an ethoxylated castor oil, dipalmitoyl-phosphatidylcholine, sodium 4-(1′ heptylnonyl)benzenesulfonate, polyoxyethylene nonyl phenyl ether, sodium dioctyl sulphosuccinate, tetraethyleneglycoldodecylether, sodium octlylbenzenesulfonate, sodium hexadecyl sulfate, sodium laureth sulfate, decylamine oxide, dodecylamine betaine, dodecylamine oxide, N,N,N-trimethyl-1-octadecammonium chloride, xylenesulfonate and salts thereof (e.g., sodium xylene sulfonate), sodium dodecyl sulfate, cetyltrimethylammonium bromide, any derivative thereof, or any combination thereof. The surfactant can be at least one of alkyl propoxy-ethoxysulfonate, alkyl propoxy-ethoxysulfate, alkylaryl-propoxy-ethoxysulfonate, a mixture of an ammonium salt of an alkyl ether sulfate, cocoamidopropyl betaine, cocoamidopropyl dimethylamine oxide, an ethoxylated alcohol ether sulfate, an alkyl or alkene amidopropyl betaine, an alkyl or alkene dimethylamine oxide, an alpha-olefinic sulfonate surfactant, any derivative thereof, and any combination thereof. Suitable surfactants may also include polymeric surfactants, block copolymer surfactants, di-block polymer surfactants, hydrophobically modified surfactants, fluoro-surfactants, and surfactants containing a non-ionic spacer-arm central extension and an ionic or nonionic polar group. In some examples, the non-ionic spacer-arm central extension can be the result of at least one of polypropoxylation and polyethoxylation.

In various embodiments, the surfactant is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate. The surfactant can be at least one of a (C₅-C₂₀)alkylsulfate salt, a (C₅-C₂₀)alkylsulfate (C₁-C₂₀)alkyl ester and a (C₅-C₂₀)alkylbisulfate. In various embodiments the surfactant is a (C₈-C₁₅)alkylsulfate salt, wherein the counterion can be any suitable counterion, such as Na⁺, K⁺, Li⁺, H⁺, Zn⁺, NH₄⁺, Ca²⁺, Mg⁺, Zn²⁺, or Al³⁺. In some embodiments, the surfactant is a (C₈-C₁₅)alkylsulfate salt sodium salt. In some embodiments, the surfactant is sodium dodecyl sulfate.

In various embodiments, the surfactant is a (C₅-C₅₀)hydrocarbyltri((C₁-C₅₀)hydrocarbyl)ammonium salt, wherein each (C₅-C₅₀)hydrocarbyl is independently selected. The counterion can be any suitable counterion, such as Na⁺, K⁺, Li⁺, H⁺, Zn⁺, NH₄⁺, Ca²⁺, Mg⁺, Zn²⁺, or Al³⁺. The surfactant can be a (C₅-C₅₀)alkyltri((C₁-C₂₀)alkyl)ammonium salt, wherein each (C₅-C₅₀)alkyl is independently selected. The surfactant can be a (C₁₀-C₃₀)alkyltri((C₁-C₁₀)alkyl)ammonium halide salt, wherein each (C₁₀-C₃₀)alkyl is independently selected. The surfactant can be cetyltrimethylammonium bromide.

### Other Components.

The composition including the friction-reducing polymer and the surfactant, or a mixture including the composition, can include any suitable additional component in any suitable proportion, such that composition, or mixture including the same, can be used as described herein.

In some embodiments, the composition includes one or more viscosifiers. The viscosifier can be any suitable viscosifier. The viscosifier can affect the viscosity of the composition or a solvent that contacts the composition at any suitable time and location. In some embodiments, the viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the viscosifier can be about 0.0001 wt % to about 10 wt % of the composition, about 0.004 wt % to about 0.01 wt % of the composition, or about 0.0001 wt % or less, 0.0005 wt %, 0.001, 0.005, 0.01, 0.05, 0.1, 0.5, 1, 2, 3, 4, 5, 6, 7, 8, 9, or about 10 wt % or more of the composition.

The viscosifier can include at least one of a substituted or unsubstituted polysaccharide, and a substituted or unsubstituted polyalkenylene, wherein the polysaccharide or polyalkenylene is crosslinked or uncrosslinked. The viscosifier can include a polymer including at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and poly((C₂-C₁₀)alkenylene), wherein the (C₂-C₁₀)alkenylene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar (e.g., hydroxypropyl guar, carboxy methyl guar, or carboxymethyl hydroxypropyl guar), gum ghatti, gum arabic, locust bean gum, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstitued (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N-(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀) alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.00001 wt % to about 5 wt % of the composition, about 0.001 wt % to about 0.01 wt %, or about 0.00001 wt % or less, or about 0.00005 wt %, 0.0001, 0.0005, 0.001, 0.005, 0.01, 0.05, 0.1, 0.5, 1, 2, 3, 4, or about 5 wt % or more.

In some embodiments, the composition can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the friction-reducing polymer and the surfactant can include any suitable downhole fluid. The composition including the friction-reducing polymer and the surfactant can be combined with any suitable downhole fluid before, during, or after the placement of the composition in the subterranean formation or the contacting of the composition and the subterranean material. In some examples, the composition including the friction-reducing polymer and the surfactant is combined with a downhole fluid above the surface, and then the combined composition is placed in a subterranean formation or contacted with a subterranean material. In another example, the composition including the friction-reducing polymer and the surfactant is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used in the subterranean formation (e.g., downhole), at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

In various embodiments, the composition including the friction-reducing polymer and the surfactant or a mixture including the same can include any suitable downhole fluid, such as an aqueous or oil-based fluid including a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition or a mixture including the same can include any suitable amount of any suitable material used in a downhole fluid. For example, the composition can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, pozzolan lime, or a combination thereof. In various embodiments, the composition can include one or more additive components such as: thinner additives such as COLDTROL®, ATC®, OMC 2™, and OMC 42™; RHEMOD™, a viscosifier and suspension agent including a modified fatty acid; additives for providing temporary increased viscosity, such as for shipping (e.g., transport to the well site) and for use in sweeps (for example, additives having the trade name TEMPERUS™ (a modified fatty acid) and VIS-PLUS®, a thixotropic viscosifying polymer blend); TAU-MOD™, a viscosifying/suspension agent including an amorphous/fibrous material; additives for filtration control, for example, ADAPTA®, a high temperature high pressure (HTHP) filtration control agent including a crosslinked copolymer; DURATONE® HT, a filtration control agent that includes an organophilic lignite, more particularly organophilic leonardite; THERMO TONE™, a HTHP filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a sized ground marble bridging agent; BAROID®, a ground barium sulfate weighting agent; BAROLIFT®, a hole sweeping agent; SWEEP-WATE®, a sweep weighting agent; BDF-508, a diamine dimer rheology modifier; GELTONE® II organophilic clay; BAROFIBRE™ 0 for lost circulation management and seepage loss prevention, including a natural cellulose fiber; STEELSEAL®, a resilient graphitic carbon lost circulation material; HYDRO-PLUG®, a hydratable swelling lost circulation material; lime, which can provide alkalinity and can activate certain emulsifiers; and calcium chloride, which can provide salinity. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the mixture with the composition including the friction-reducing polymer and the surfactant in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, or about 99.999 wt % or more of the mixture.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{+h} ed. 1988). An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the friction-reducing polymer and the surfactant can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, about 0 wt % to about 95 wt %, about 20 wt % to about 95 wt %, or about 50 wt % to about 90 wt %. A cement kiln dust can be present in an amount of at least about 0.01 wt %, or about 5 wt % to about 80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### Drilling Assembly.

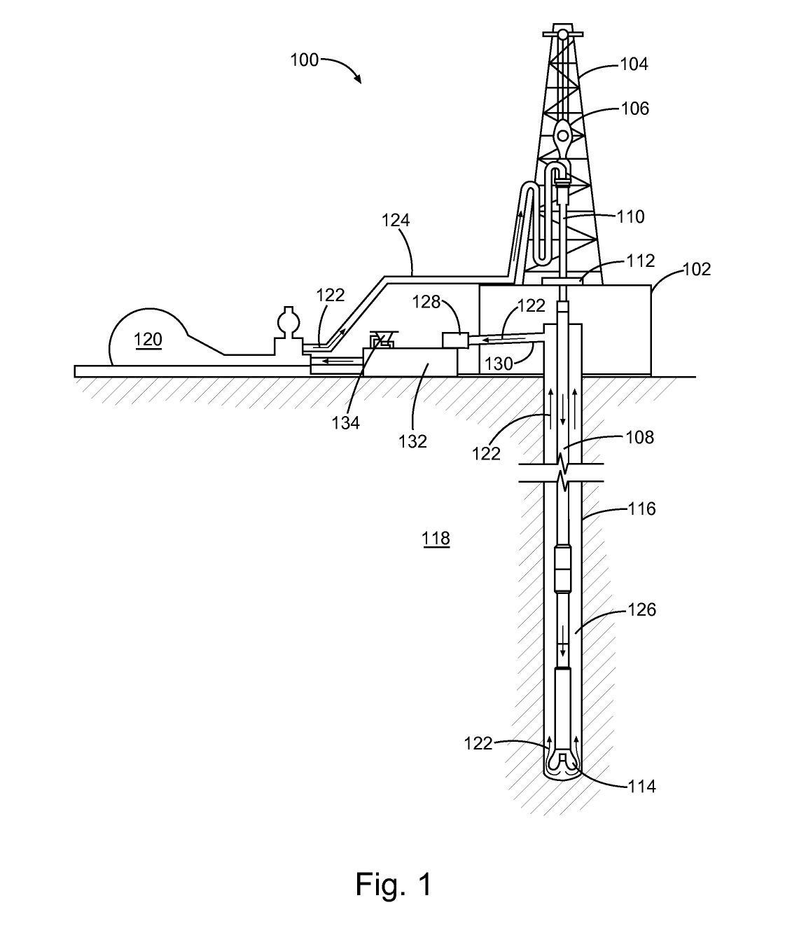

In various embodiments, the composition including the friction-reducing polymer and the surfactant disclosed herein can directly or indirectly affect one or more components or pieces of equipment associated with the preparation, delivery, recapture, recycling, reuse, and/or disposal of the disclosed composition including the friction-reducing polymer and the surfactant. For example, and with reference to FIG. 1, the disclosed composition including the friction-reducing polymer and the surfactant can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the friction-reducing polymer and the surfactant can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the friction-reducing polymer and the surfactant can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the friction-reducing polymer and the surfactant can be stored, reconditioned, and/or regulated until added to the drilling fluid 122.

As mentioned above, the composition including the friction-reducing polymer and the surfactant can directly or indirectly affect the components and equipment of the drilling assembly 100. For example, the composition including the friction-reducing polymer and the surfactant can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the friction-reducing polymer and the surfactant.

The composition including the friction-reducing polymer and the surfactant can directly or indirectly affect the pump 120, which representatively includes any conduits, pipelines, trucks, tubulars, and/or pipes used to fluidically convey the composition including the friction-reducing polymer and the surfactant to the subterranean formation, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The composition including the friction-reducing polymer and the surfactant can also directly or indirectly affect the mixing hopper 134 and the retention pit 132 and their assorted variations.

The composition including the friction-reducing polymer and the surfactant can also directly or indirectly affect the various downhole or subterranean equipment and tools that can come into contact with the composition including the friction-reducing polymer and the surfactant such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the friction-reducing polymer and the surfactant can also directly or indirectly affect any downhole heat exchangers, valves and corresponding actuation devices, tool seals, packers and other wellbore isolation devices or components, and the like associated with the wellbore 116. The composition including the friction-reducing polymer and the surfactant can also directly or indirectly affect the drill bit 114, which can include roller cone bits, polycrystalline diamond compact (PDC) bits, natural diamond bits, any hole openers, reamers, coring bits, and the like.

While not specifically illustrated herein, the composition including the friction-reducing polymer and the surfactant can also directly or indirectly affect any transport or delivery equipment used to convey the composition including the friction-reducing polymer and the surfactant to the drilling assembly 100 such as, for example, any transport vessels, conduits, pipelines, trucks, tubulars, and/or pipes used to fluidically move the composition including the friction-reducing polymer and the surfactant from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition including the friction-reducing polymer and the surfactant described herein. The system can include a composition including the friction-reducing polymer and the surfactant. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), the tubular containing a composition including the friction-reducing polymer and the surfactant described herein.

In some embodiments, the system can include a drillstring disposed in a wellbore, the drillstring including a drill bit at a downhole end of the drillstring. The system can also include an annulus between the drillstring and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

In various embodiments, the present invention provides an apparatus. The apparatus can be any suitable apparatus can use or that can be generated by use of the composition including the friction-reducing polymer and the surfactant described herein in a subterranean formation, or that can perform or be generated by performance of a method for using the composition described herein.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

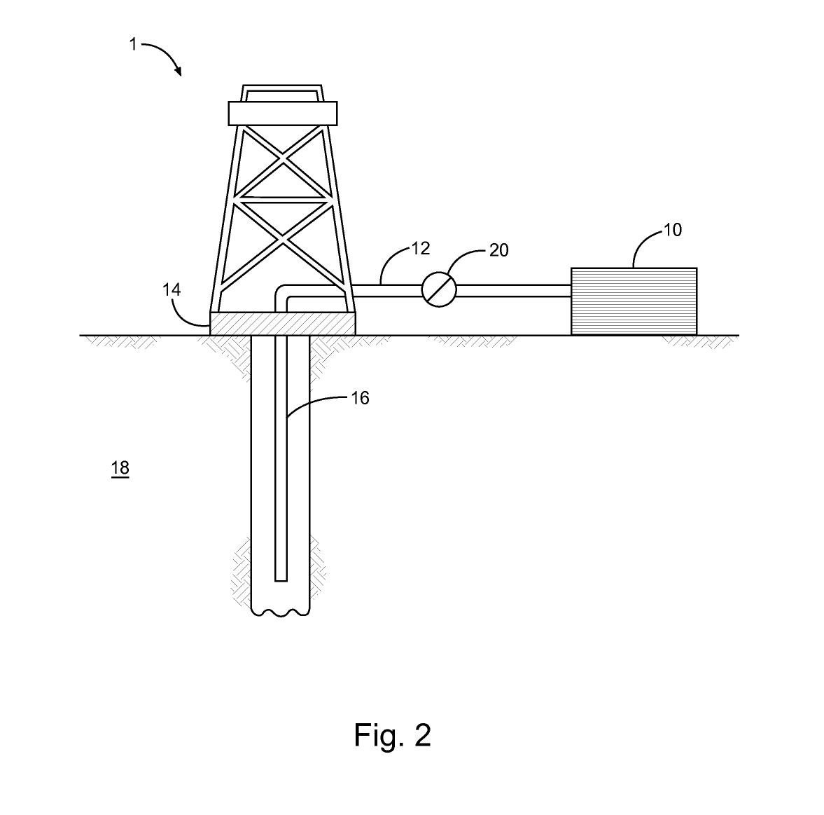

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can substantially retain the original concentration of at least one of the friction-reducing polymer and the surfactant, be substantially diminished in the concentration of at least one of the friction-reducing polymer and the surfactant, or can have substantially none of at least one of the friction-reducing polymer and the surfactant therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation, wherein the composition includes a friction-reducing polymer and a surfactant. The composition can be any suitable composition that can be used to perform an embodiment of the method for treatment of a subterranean formation described herein.

In some embodiments, the composition includes a brine. For example, about 50 wt % to about 99.999 wt % of the composition can be a brine, such as a brine having a total dissolved solids level of about 100,000 ppm to about 500,000 ppm.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including a friction-reducing polymer and a surfactant.

### EXAMPLES

Various embodiments of the present invention can be better understood by reference to the following Examples which are offered by way of illustration. The present invention is not limited to the Examples given herein.

### Example 1

### Partially Hydrolyzed Acrylamide Friction-Reducer with Sodium Dodecyl Sulfate

Two samples of a 1 gallon per thousand gallons (GPT) partially hydrolyzed acrylamide friction-reducer in a brine having a total dissolved solids level of 150,000 ppm were prepared. One sample included no surfactant, and one sample included 0.1 wt % sodium dodecyl sulfate surfactant. The friction-reducer was an oil-external emulsion of 25-30 wt % polyacrylamide having 30 mol % hydrolyzed acrylamide units, having a MW of about 10,000,000, with about 65 vol % hydrocarbon external phase (hydrotreated light petroleum distillate) and about 35 vol % internal phase.

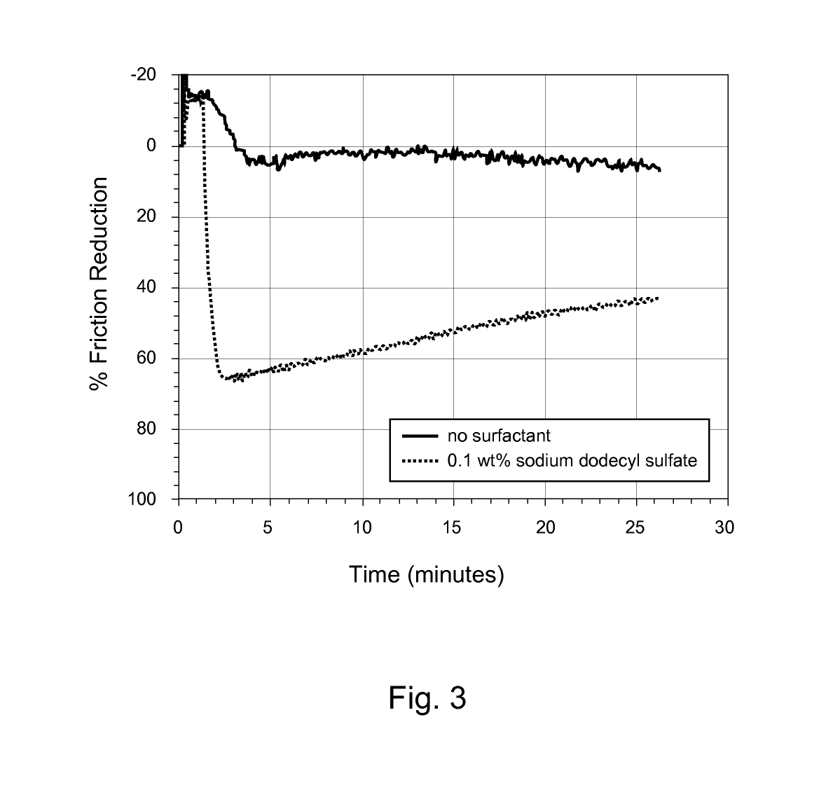

The percent friction reduction was analyzed by pumping the samples at 10 gallons per minute through a ½″ diameter friction loop while measuring the pressure drop between two pressure transducers. The percent friction reduction was calculated based on the measured pressure drop of fresh water at the same tested flow rate and ambient temperature and pressure. FIG. 3 illustrates the percent friction reduction of the samples.

### Example 2

### Ampholyte Terpolymer Friction-Reducer with Cetyltrimethlyammonium Bromide

Three samples of a 1 GPT ampholyte terpolymer friction-reducer in brine having a total dissolved solids level of 250,000 ppm were prepared. One sample included no surfactant, one sample included 0.01 wt % cetyltrimethylammonium bromide (CTAB), and one sample included 0.1 wt % CTAB. The ampholyte terpolymer friction-reducer was used in an oil-external emulsion and was a terpolymer of acrylamide, 2-acrylamido-2-methylpropane sulfonic acid (AMPS), and acryloyloxy ethyl trimethyl ammonium chloride (AETAC:), the terpolymer having 40 wt % monomers from acrylamide, 10 wt % monomers from AMPS, and 50 wt % monomers from AETAC. The oil-external emulsion had 25-30 wt % aqueous internal phase and about 75-80 wt % hydrocarbon external phase, and included 20-30 wt % of the ampholyte terpolymer.

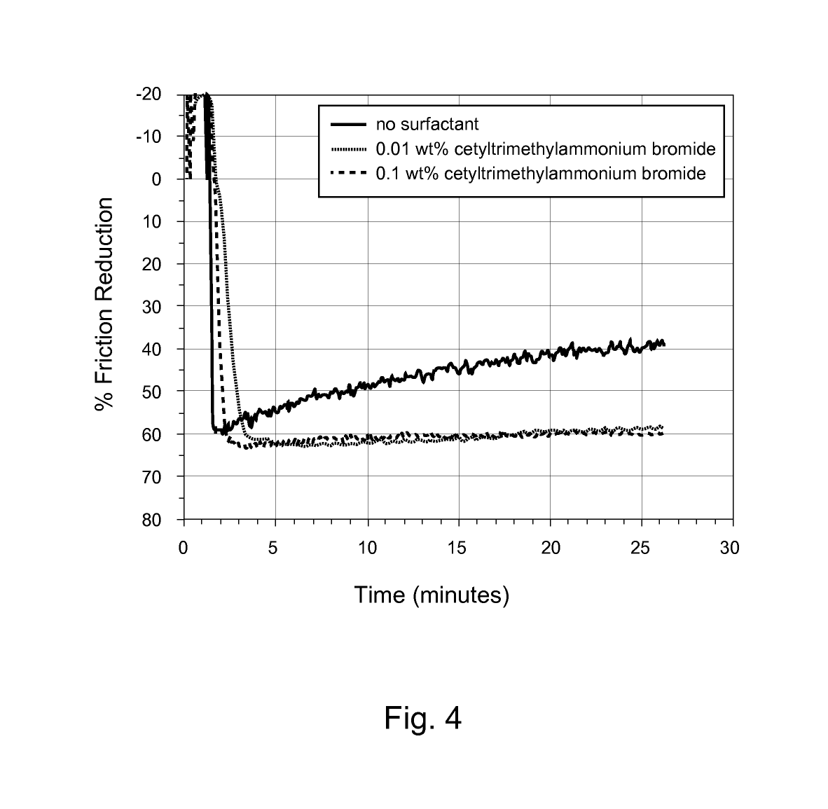

The percent friction reduction was analyzed by pumping the samples at 10 gallons per minute through a ½″ diameter friction loop while measuring the pressure drop between two pressure transducers. The percent friction reduction was calculated based on the measured pressure drop of fresh water at the same tested flow rate and ambient temperature and pressure. FIG. 3 illustrates the percent friction reduction of the samples. FIG. 4 illustrates the percent friction reduction of the samples.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:
obtaining or providing a composition comprising
   a friction-reducing polymer; and
   a surfactant; and
placing the composition in a subterranean formation.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs in the subterranean formation.

Embodiment 4 provides the method of any one of Embodiments 1-3, wherein the method is a method of hydraulic fracturing.

Embodiment 5 provides the method of any one of Embodiments 1-4, wherein the composition is a fracturing fluid.

Embodiment 6 provides the method of any one of Embodiments 1-5, wherein the placing of the composition in the subterranean formation is sufficient to fracture the subterranean formation.

Embodiment 7 provides the method of any one of Embodiments 1-6, wherein the method comprises a method of pumping a liquid into a subterranean formation.

Embodiment 8 provides the method of any one of Embodiments 1-7, wherein the composition further comprises an aqueous liquid.

Embodiment 9 provides the method of Embodiment 8, wherein the method further comprises mixing the aqueous liquid with the friction-reducing polymer and the surfactant.

Embodiment 10 provides the method of Embodiment 9, wherein the mixing occurs above surface.

Embodiment 11 provides the method of any one of Embodiments 9-10, wherein the mixing occurs in the subterranean formation.

Embodiment 12 provides the method of any one of Embodiments 8-11, wherein the aqueous liquid comprises at least one of water, brine, produced water, flowback water, brackish water, and sea water.

Embodiment 13 provides the method of any one of Embodiments 8-12, wherein the aqueous liquid is salt water having a total dissolved solids level of about 1,000 mg/L to about 500,000 mg/L.

Embodiment 14 provides the method of any one of Embodiments 1-13, wherein the composition is sufficient such that, as compared to a corresponding composition not including the surfactant, the composition including the surfactant provides about 1% to about 200% greater friction reduction.

Embodiment 15 provides the method of any one of Embodiments 1-14, wherein the composition is sufficient such that, as compared to a corresponding composition not including the surfactant, the composition provides about 30% to 60% greater friction reduction.

Embodiment 16 provides the method of any one of Embodiments 14-15, wherein the percent friction reduction is measured as the pressure drop in a ½ inch-diameter friction loop with a pumping rate of 10 gallons per minute as compared to the pressure drop of a sample not including the friction-reducing polymer or the surfactant, wherein the percent friction reduction is measured between 5 and 20 minutes after the pumping begins, wherein the composition comprises about 0.01 wt % to about 10 wt % of the friction-reducing polymer and about 0.001 wt % to about 1 wt % of the surfactant, and wherein the composition comprises about 89 wt % to about 99.999 wt % of brine having a total dissolved solids level of about 100,000 ppm to about 300,000 ppm.

Embodiment 17 provides the method of any one of Embodiments 1-16, wherein about 0.001 wt % to about 80 wt % of the composition is the friction-reducing polymer.

Embodiment 18 provides the method of any one of Embodiments 1-17, wherein about 0.01 wt % to about 10 wt % of the composition is the friction-reducing polymer.

Embodiment 19 provides the method of any one of Embodiments 1-18, wherein the friction-reducing polymer is an ionic friction-reducing polymer.

Embodiment 20 provides the method of any one of Embodiments 1-19, wherein the friction-reducing polymer comprises at least one monomer derived from a compound selected from the group consisting of a carboxylic acid-substituted (C₂-C₂₀)alkene, a (C₂-C₂₀)alkylene oxide, a ((C₁-C₂₀)hydrocarbyl (C₁-C₂₀)alkanoic acid ester)-substituted (C₂-C₂₀)alkene, a ((C₁-C₂₀)alkanoic acid salt)-substituted (C₂-C₂₀)alkene, a (C₁-C₂₀)alkanoyloxy(C₁-C₂₀)hydrocarbyl tri(C₁-C₂₀)hydrocarbylammonium salt, a (substituted or unsubstituted amide)-substituted (C₂-C₂₀)alkene, a sulfonic acid-, sulfonic acid (C₁-C₂₀)hydrocarbyl ester-, or sulfonic acid salt-substituted (C₂-C₂₀)alkene, a (sulfonic acid (C₁-C₂₀)hydrocarbyl ester-, or sulfonic acid salt-substituted (C₁-C₂₀)hydrocarbylamido)-substituted (C₂-C₂₀)alkene, an N—(C₂-C₂₀)alkenyl (C₂-C₂₀)alkanoic acid amide, and a mono-, di-, tri-, or tetra-(C₂-C₂₀)alkenyl-substituted ammonium salt wherein the ammonium group is further substituted or unsubstituted, wherein each hydrocarbyl, alkene, alkylene, alkanoic, and alkanoyl group is independently interrupted or terminated with 0, 1, 2, or 3 groups chosen from —O—, —NH—, and —S—, wherein each hydrocarbyl, alkene, alkylene, alkanoic, and alkanoyl group is independently further substituted or further unsubstituted.

Embodiment 21 provides the method of any one of Embodiments 1-20, wherein the friction-reducing polymer comprises at least one monomer derived from a compound selected from the group consisting of acrylamide, acrylic acid or a salt thereof, 2-acrylamido-2-methylpropane sulfonic acid or a salt thereof, N,N-dimethylacrylamide, vinyl sulfonic acid or a salt thereof, N-vinyl acetamide, N-vinyl formamide, itaconic acid or a salt thereof, methacrylic acid or a salt thereof, acrylic acid ester, methacrylic acid ester, diallyl dimethyl ammonium chloride, dimethylaminoethyl acrylate, acryloyloxy ethyl trimethyl ammonium chloride, ethylene oxide, and 2-(2-ethoxyethoxy)-ethyl acrylate.

Embodiment 22 provides the method of any one of Embodiments 1-21, wherein the composition further comprises a complexing agent.

Embodiment 23 provides the method of any one of Embodiments 1-22, wherein the friction-reducing polymer is a polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted (C₅-C₅₀)hydrocarbyl,
at each occurrence R² is independently selected from the group consisting of —NH₂ and —OR³, wherein at each occurrence R³ is independently selected from the group consisting of —R¹, —H, and a counterion,
the repeating units are in block, alternate, or random configuration, Z¹ is about 0% to about 50%, N¹ is about 50% to about 100%, and Z¹+N¹ is about 100%.

Embodiment 24 provides the method of any one of Embodiments 1-23, wherein the friction-reducing polymer comprises repeating units having the structure:

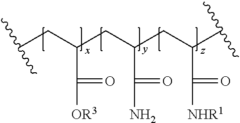

wherein
   at each occurrence R¹ is independently C₅-C₅₀ alkyl;
   at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
   the repeating units are in a block, alternate, or random configuration, each repeating unit is independently in the orientation shown or in the opposite orientation, and
   x/(x+y+z) is about 0% to about 100%, y/(x+y+z) is about 0% to about 100%, z/(x+y+z) is about 0% to about 50%, and x + y is greater than zero.

Embodiment 25 provides the method of any one of Embodiments 1-24, wherein the friction-reducing polymer is an ampholyte polymer comprising an ethylene repeating unit comprising a —C(O)NH₂ group, an ethylene repeating unit comprising an —S(O)₂OR¹¹ group, and an ethylene repeating unit comprising an —N⁺R¹²₃X⁻ group, wherein
at each occurrence, R¹¹ is independently selected from the group consisting of —H and a counterion,
at each occurrence, R¹² is independently substituted or unsubstituted (C₁-C₂₀)hydrocarbyl, and
at each occurrence, X⁻ is independently a counterion.

Embodiment 26 provides the method of any one of Embodiments 1-25, wherein the friction-reducing polymer is an ampholyte polymer comprising repeating units having the structure:

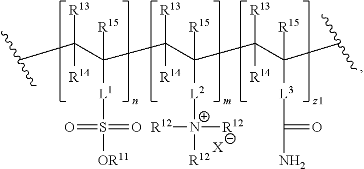

wherein
   at each occurrence R¹³, R¹⁴, and R¹⁵ are each independently selected from the group consisting of —H and a substituted or unsubstituted C₁-C₅ hydrocarbyl,
   at each occurrence L¹, L², and L³ are each independently selected from the group consisting of a bond and a substituted or unsubstituted C₁-C₂₀ hydrocarbyl interrupted or terminated with 0, 1, 2, or 3 of at least one of —NR¹³—, —S—, and —O—, and
   the repeating units are in a block, alternate, or random configuration, and each repeating unit is independently in the orientation shown or in the opposite orientation.

Embodiment 27 provides the method of any one of Embodiments 1-26, wherein the friction-reducing polymer is an ampholyte polymer comprising repeating units having the structure:

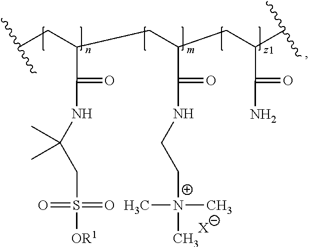

wherein
   at each occurrence, R¹¹ is independently selected from the group consisting of —H and a counterion,
   the repeating units are in a block, alternate, or random configuration, and each repeating unit is independently in the orientation shown or in the opposite orientation,
   the polymer has a molecular weight of about 100,000 g/mol to about 20,000,000 g/mol, and
   the polymer has about 30 wt % to about 50 wt % of the ethylene repeating unit comprising the —C(O)NH₂ group, about 5 wt % to about 15 wt % of the ethylene repeating unit comprising the —S(O)₂OR¹¹ group, and about 40 wt % to about 60 wt % of the ethylene repeating unit comprising the —N⁺R¹²₃X⁻ group.

Embodiment 28 provides the method of any one of Embodiments 1-27, wherein about 0.0001 wt % to about 20 wt % of the composition is the surfactant.

Embodiment 29 provides the method of any one of Embodiments 1-28, wherein about 0.001 wt % to about 1 wt % of the composition is the surfactant.

Embodiment 30 provides the method of any one of Embodiments 1-29, wherein the surfactant is at least one of a cationic surfactant, an anionic surfactant, and a non-ionic surfactant.

Embodiment 31 provides the method of any one of Embodiments 1-30, wherein the surfactant is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate.

Embodiment 32 provides the method of any one of Embodiments 1-31, wherein the surfactant is a (C₅-C₂₀)alkylsulfate salt.

Embodiment 33 provides the method of any one of Embodiments 1-32, wherein the surfactant is a (C₈-C₁₅)alkylsulfate sodium salt

Embodiment 34 provides the method of any one of Embodiments 1-33, wherein the surfactant is a (C₅-C₅₀)hydrocarbyltri((C₁-C₅₀)hydrocarbyl)ammonium salt, wherein each (C₅-C₅₀)hydrocarbyl is independently selected.

Embodiment 35 provides the method of any one of Embodiments 1-34, wherein the surfactant is a (C₅-C₅₀)alkyltri((C₁-C₂₀)alkyl)ammonium salt, wherein each (C₅-C₅₀)alkyl is independently selected.

Embodiment 36 provides the method of any one of Embodiments 1-35, wherein the surfactant is a (C₁₀-C₃₀)alkyltri((C₁-C₁₀)alkyl)ammonium halide salt, wherein each (C₁₀-C₃₀)alkyl is independently selected.

Embodiment 37 provides the method of any one of Embodiments 1-36, wherein the surfactant is at least one of sodium dodecyl sulfate and cetyltrimethylammonium bromide.

Embodiment 38 provides the method of any one of Embodiments 1-37, wherein the composition comprises an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

Embodiment 39 provides the method of any one of Embodiments 1-38, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof, to form a mixture, wherein the placing the composition in the subterranean formation comprises placing the mixture in the subterranean formation.

Embodiment 40 provides the method of any one of Embodiments 1-39, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

Embodiment 41 provides the method of any one of Embodiments 1-40, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 42 provides the method of any one of Embodiments 1-41, wherein the composition further comprises a proppant, a resin-coated proppant, or a combination thereof.

Embodiment 43 provides the method of any one of Embodiments 1-42, wherein the placing of the composition in the subterranean formation comprises pumping the composition through a drill string disposed in a wellbore, through a drill bit at a downhole end of the drill string, and back above-surface through an annulus.

Embodiment 44 provides the method of Embodiment 43, further comprising processing the composition exiting the annulus with at least one fluid processing unit to generate a cleaned composition and recirculating the cleaned composition through the wellbore.

Embodiment 45 provides a system for performing the method of any one of Embodiments 1-44, the system comprising:
a tubular disposed in the subterranean formation; and
a pump configured to pump the composition in the subterranean formation through the tubular.

Embodiment 46 provides a system for performing the method of any one of Embodiments 1-44, the system comprising:
a drillstring disposed in a wellbore, the drillstring comprising a drill bit at a downhole end of the drillstring;
an annulus between the drillstring and the wellbore; and
a pump configured to circulate the composition through the drill string, through the drill bit, and back above-surface through the annulus.

Embodiment 47 provides a method of treating a subterranean formation, the method comprising:
obtaining or providing a composition comprising
   about 0.001 wt % to about 80 wt % of a friction-reducing polymer that is at least one of
      a polymer comprising about Z¹ mol % of an ethylene repeating unit comprising a —C(O)NHR¹ group and comprising about N¹ mol % of an ethylene repeating unit comprising a —C(O)R² group, wherein
         at each occurrence R¹ is independently a substituted or unsubstituted (C₅-C₅₀)hydrocarbyl,
         at each occurrence R² is independently selected from the group consisting of —NH₂ and —OR³, wherein at each occurrence R³ is independently selected from the group consisting of —R¹, —H, and a counterion,
         the repeating units are in block, alternate, or random configuration, Z¹ is about 0% to about 50%, N¹ is about 50% to about 100%, and Z¹+N¹ is about 100%; and
      an ampholyte polymer comprising an ethylene repeating unit comprising a —C(O)NH₂ group, an ethylene repeating unit comprising an —S(O)₂OR¹¹ group, and an ethylene repeating unit comprising an —N⁺R¹²₃X⁻ group, wherein
         at each occurrence, R¹¹ is independently selected from the group consisting of —H and a counterion,
         at each occurrence, R¹² is independently substituted or unsubstituted (C₁-C₂₀)hydrocarbyl, and
         at each occurrence, X⁻ is independently a counterion; and
   about 0.0001 wt % to about 20 wt % of a surfactant that is
      at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate,
      a (C₅-C₅₀)hydrocarbyltri((C₁-C₅₀)hydrocarbyl)ammonium salt, wherein each (C₅-C₅₀)hydrocarbyl is independently selected, or
      a combination thereof; and
placing the composition in a subterranean formation.

Embodiment 48 provides the method of Embodiment 47, wherein about the composition comprises about 50 wt % to about 99.999 wt % of a brine having a total dissolved solids level of about 100,000 ppm to about 500,000 ppm.

Embodiment 49 provides a method of treating a subterranean formation, the method comprising:
obtaining or providing a composition comprising
   about 0.001 wt % to about 80 wt % of a friction-reducing polymer that is at least one of
      a polymer comprising repeating units having the structure:

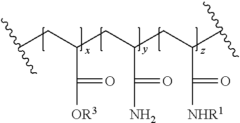

wherein
   at each occurrence R¹ is independently C₅-C₅₀ alkyl;
   at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
   the repeating units are in a block, alternate, or random configuration, each repeating unit is independently in the orientation shown or in the opposite orientation, and
   x/(x+y+z) is about 0% to about 100%, y/(x+y+z) is about 0% to about 100%, z/(x+y+z) is about 0% to about 50%, and x + y is greater than zero; and
an ampholyte polymer comprising repeating units having the structure:

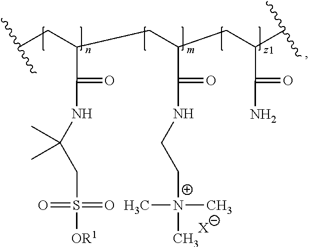

wherein
   at each occurrence, R¹¹ is independently selected from the group consisting of —H and a counterion,
   the repeating units are in a block, alternate, or random configuration, and each repeating unit is independently in the orientation shown or in the opposite orientation,
   the polymer has a molecular weight of about 100,000 g/mol to about 20,000,000 g/mol, and
   the polymer has about 30 wt % to about 50 wt % of the ethylene repeating unit comprising the —C(O)NH₂ group, about 5 wt % to about 15 wt % of the ethylene repeating unit comprising the —S(O)₂OR¹¹ group, and about 40 wt % to about 60 wt % of the ethylene repeating unit comprising the —N⁺R¹²₃X⁻ group;
about 0.0001 wt % to about 20 wt % of a surfactant that is at least one of a dodecyl sulfate salt and a cetyltrimethylammonium salt; and
about 50 wt % to about 99.999 wt % of a brine having a total dissolved solids level of about 100,000 ppm to about 500,000 ppm; and
placing the composition in a subterranean formation.

Embodiment 50 provides a system comprising:
a composition comprising
   a friction-reducing polymer; and
   a surfactant; and
a subterranean formation comprising the composition therein.

Embodiment 51 provides the system of Embodiment 50, further comprising
a drillstring disposed in a wellbore, the drillstring comprising a drill bit at a downhole end of the drillstring;
an annulus between the drillstring and the wellbore; and
a pump configured to circulate the composition through the drill string, through the drill bit, and back above-surface through the annulus.

Embodiment 52 provides the system of Embodiment 51, further comprising a fluid processing unit configured to process the composition exiting the annulus to generate a cleaned drilling fluid for recirculation through the wellbore.

Embodiment 53 provides the system of any one of Embodiments 50-52, further comprising
a tubular disposed in the subterranean formation;
a pump configured to pump the composition in the subterranean formation through the tubular.

Embodiment 54 provides a composition for treatment of a subterranean formation, the composition comprising:
a friction-reducing polymer; and
a surfactant.

Embodiment 55 provides the composition of Embodiment 54, wherein the composition further comprises a downhole fluid.

Embodiment 56 provides the composition of any one of Embodiments 54-55, wherein the composition further comprises a brine having a total dissolved solids level of about 100,000 ppm to about 500,000 ppm.

Embodiment 57 provides the composition of any one of Embodiments 54-56, wherein the composition is a composition for fracturing of a subterranean formation.

Embodiment 58 provides a composition for treatment of a subterranean formation, the composition comprising:
about 0.001 wt % to about 80 wt % of a friction-reducing polymer that is at least one of
   a polymer comprising about Z¹ mol % of an ethylene repeating unit comprising a —C(O)NHR¹ group and comprising about N¹ mol % of an ethylene repeating unit comprising a —C(O)R² group, wherein
      at each occurrence R¹ is independently a substituted or unsubstituted (C₅-C₅₀)hydrocarbyl,
      at each occurrence R² is independently selected from the group consisting of —NH₂ and —OR³, wherein at each occurrence R³ is independently selected from the group consisting of —R¹, —H, and a counterion,
      the repeating units are in block, alternate, or random configuration, Z¹ is about 0% to about 50%, N¹ is about 50% to about 100%, and Z¹+N¹ is about 100%; and
   an ampholyte polymer comprising an ethylene repeating unit comprising a —C(O)NH₂ group, an ethylene repeating unit comprising an —S(O)₂OR¹¹ group, and an ethylene repeating unit comprising an —N⁺R¹²₃X⁻ group, wherein
      at each occurrence, R¹¹ is independently selected from the group consisting of —H and a counterion,
      at each occurrence, R¹² is independently substituted or unsubstituted (C₁-C₂₀)hydrocarbyl, and
      at each occurrence, X⁻ is independently a counterion; and
about 0.0001 wt % to about 20 wt % of a surfactant that is
   at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate,
   a (C₅-C₅₀)hydrocarbyltri((C₁-C₅₀)hydrocarbyl)ammonium salt, wherein each (C₅-C₅₀)hydrocarbyl is independently selected, or
   a combination thereof.

Embodiment 59 provides the composition of Embodiment 58, wherein about the composition comprises about 50 wt % to about 99.999 wt % of a brine having a total dissolved solids level of about 100,000 ppm to about 500,000 ppm.

Embodiment 60 provides a method of preparing a composition for treatment of a subterranean formation, the method comprising:
forming a composition comprising
   a friction-reducing polymer; and
   a surfactant.

Embodiment 61 provides the composition, method, or system of any one or any combination of Embodiments 1-60 optionally configured such that all elements or options recited are available to use or select from.

1-60. (canceled)

61. A method of treating a subterranean formation, the method comprising:
placing in the subterranean formation a composition comprising
a friction-reducing polymer; and
a surfactant.

62. The method of claim 61, wherein the placing of the composition in the subterranean formation is sufficient to fracture the subterranean formation.

63. The method of claim 61, wherein the composition is sufficient such that, as compared to a corresponding composition not including the surfactant, the composition including the surfactant provides about 1% to about 200% greater friction reduction.

64. The method of claim 61, wherein about 0.001 wt % to about 80 wt % of the composition is the friction-reducing polymer.

65. The method of claim 61, wherein the friction-reducing polymer is an ionic friction-reducing polymer.

66. The method of claim 61, wherein the friction-reducing polymer comprises at least one monomer derived from a compound selected from the group consisting of a carboxylic acid-substituted (C₂-C₂₀)alkene, a (C₂-C₂₀)alkylene oxide, a ((C₁-C₂₀)hydrocarbyl (C₁-C₂₀)alkanoic acid ester)-substituted (C₂-C₂₀)alkene, a ((C₁-C₂₀)alkanoic acid salt)-substituted (C₂-C₂₀)alkene, a (C₁-C₂₀)alkanoyloxy(C₁-C₂₀)hydrocarbyl tri(C₁-C₂₀)hydrocarbylammonium salt, a (substituted or unsubstituted amide)-substituted (C₂-C₂₀)alkene, a sulfonic acid-, sulfonic acid (C₁-C₂₀)hydrocarbyl ester-, or sulfonic acid salt-substituted (C₂-C₂₀)alkene, a (sulfonic acid (C₁-C₂₀)hydrocarbyl ester-, or sulfonic acid salt-substituted (C₁-C₂₀)hydrocarbylamido)-substituted (C₂-C₂₀)alkene, an N-(C₂-C₂₀)alkenyl (C₂-C₂₀)alkanoic acid amide, and a mono-, di-, tri-, or tetra-(C₂-C₂₀)alkenyl-substituted ammonium salt wherein the ammonium group is further substituted or unsubstituted, wherein each hydrocarbyl, alkene, alkylene, alkanoic, and alkanoyl group is independently interrupted or terminated with 0, 1, 2, or 3 groups chosen from —O—, —NH—, and —S—, wherein each hydrocarbyl, alkene, alkylene, alkanoic, and alkanoyl group is independently further substituted or further unsubstituted.

67. The method of claim 61, wherein the friction-reducing polymer comprises at least one monomer derived from a compound selected from the group consisting of acrylamide, acrylic acid or a salt thereof, 2-acrylamido-2-methylpropane sulfonic acid or a salt thereof, N,N-dimethylacrylamide, vinyl sulfonic acid or a salt thereof, N-vinyl acetamide, N-vinyl formamide, itaconic acid or a salt thereof, methacrylic acid or a salt thereof, acrylic acid ester, methacrylic acid ester, diallyl dimethyl ammonium chloride, dimethylaminoethyl acrylate, acryloyloxy ethyl trimethyl ammonium chloride, ethylene oxide, and 2-(2-ethoxyethoxy)-ethyl acrylate,

68. The method of claim 61, wherein the friction-reducing polymer is a polymer comprising about Z¹ mol % of an ethylene repeating unit comprising a —C(O)NHR¹ group and comprising about N¹ mol % of an ethylene repeating unit comprising a —C(O)R² group, wherein at each occurrence R¹ is independently a substituted or unsubstituted (C₅-C₅₀)hydrocarbyl,
at each occurrence R¹ is independently selected from the group consisting of —NH₂ and —OR³, wherein at each occurrence R³ is independently selected from the group consisting of —R¹, —H, and a counterion,
the repeating units are in block, alternate, or random configuration, Z¹ is about 0% to about 50%, N¹ is about 50% to about 100%, and Z¹+N¹ is about 100%.

69. The method of claim 61, wherein the friction-reducing polymer comprises repeating units having the structure: 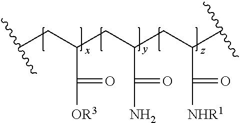
wherein
at each occurrence R¹ is independently C₅-C₅₀ alkyl;
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x/(x+y+z) is about 0% to about 100%, y/(x+y+z) is about 0% to about 100%, z/(x+y+z) is about 0% to about 50%, and x+y is greater than zero.

70. The method of claim 61, wherein the friction-reducing polymer is an ampholyte polymer comprising an ethylene repeating unit comprising a —C(O)NH₂ group, an ethylene repeating unit comprising an —S(O)₂OR¹¹ group, and an ethylene repeating unit comprising an —N⁺R¹²₃X⁻ group, wherein
at each occurrence, R¹¹ is independently selected from the group consisting of —H and a counterion,
at each occurrence, R¹² is independently substituted or unsubstituted C₂₀)hydrocarbyl, and
at each occurrence, X⁻ is independently a counterion.

71. The method of claim 61, wherein the friction-reducing polymer is an ampholyte polymer comprising repeating units having the structure: 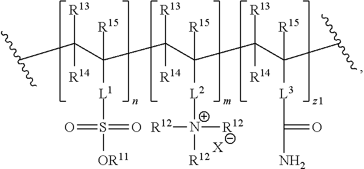
wherein
at each occurrence R¹³, R¹⁴, and R¹⁵ are each independently selected from the group consisting of —H and a substituted or unsubstituted C₁-C₅ hydrocarbyl,
at each occurrence L¹, L², and L³ are each independently selected from the group consisting of a bond and a substituted or unsubstituted C₁-C₂₀ hydrocarbyl interrupted or terminated with 0, 1, 2, or 3 of at least one of —NR¹³—, —S—, and —O—, and
the repeating units are in a block, alternate, or random configuration, and each repeating unit is independently in the orientation shown or in the opposite orientation.

72. The method of claim 61, wherein the friction-reducing polymer is an ampholyte polymer comprising repeating units having the structure: 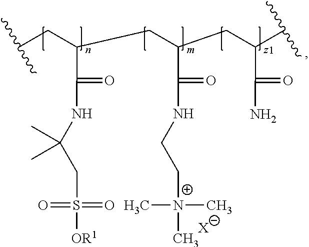
wherein
at each occurrence, R¹¹ is independently selected from the group consisting of —H and a counterion,
the repeating units are in a block, alternate, or random configuration, and each repeating unit is independently in the orientation shown or in the opposite orientation,
the polymer has a molecular weight of about 100,000 g/mol to about 20,000,000 g/mol, and
the polymer has about 30 wt % to about 50 wt % of the ethylene repeating unit comprising the —C(O)NH₂ group, about 5 wt % to about 15 wt % of the ethylene repeating unit comprising the —S(O)₂OR¹¹ group, and about 40 wt % to about 60 wt % of the ethylene repeating unit comprising the —N⁺R¹²₃X⁻ group.

73. The method of claim 61, wherein about 0.0001 wt % to about 20 wt % of the composition is the surfactant.

74. The method of claim 61, wherein the surfactant is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C50)hydrocarbylbisulfate.

75. The method of claim 61, wherein the surfactant is a (C₅-C₅₀)hydrocarbyltri((C₁-C₅₀)hydrocarbyl)ammonium salt, wherein each (C₅-C₅₀)hydrocarbyl is independently selected.

76. The method of claim 61, wherein the surfactant s at least one of sodium dodecyl sulfate and cetyltrimethylammonium bromide.

77. The method of claim 61, wherein the composition further comprises a proppant, a resin-coated proppant, or a combination thereof.

78. A system for performing the method of claim 61, the system comprising:
a tubular disposed in the subterranean formation; and
a pump configured to pump the composition in the subterranean formation through the tubular.

79. A method of treating a subterranean formation, the method comprising:
placing in the subterranean formation a composition comprising
about 0.001 wt % to about 80 wt % of a friction-reducing polymer that is at least one of
a polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted (C₅-C₅₀)hydrocarbyl,
at each occurrence R² is independently selected from the group consisting of —NH₂ and —OR³, wherein at each occurrence R³ is independently selected from the group consisting of —R¹, —H, and a counterion,
the repeating units are in block, alternate, or random configuration, Z¹ is about 0% to about 50%, N¹ is about 50% to about 100%, and Z¹+N¹ is about 100%; and
an ampholyte polymer comprising an ethylene repeating unit comprising a —C(O)NH₂ group, an ethylene repeating unit comprising an —S(O)₂OR¹¹ group, and an ethylene repeating unit comprising an —N⁻R¹²₃X⁻ group, wherein
at each occurrence, R¹¹ is independently selected from the group consisting of —H and a counterion,
at each occurrence, R¹² is independently substituted or unsubstituted (C₁-C₂₀)hydrocarbyl, and
at each occurrence, X⁻ is independently a counterion; and
about 0.0001 wt % to about 20 wt % of a surfactant that is
at least one of a substituted or unsubstituted (C₅-C₅₀)lydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate,
a (C₅-C₅₀)hydrocarbyltri((C₁-C₅₀)hydrocarbyl)ammonium salt, wherein each (C₅-C₅₀)hydrocarbyl is independently selected, or
a combination thereof.

80. A method of treating a subterranean formation, the method comprising:
placing in the subterranean formation a composition comprising
about 0.001 wt % to about 80 wt % of a friction-reducing polymer that is at least one of
a polymer comprising repeating units having the structure: 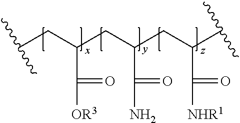
wherein
at each occurrence R¹ is independently C₅-C₅₀ alkyl;
at each occurrence R² is independently selected from the group consisting —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x/(x+y+z) is about 0% to about 100%, y/(x+y+z) is about 0% to about 100%, z/(x+y+z) is about 0% to about 50%, and x+y is greater than zero; and
an ampholyte polymer comprising repeating units haying the structure: 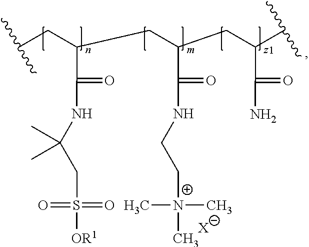
wherein
at each occurrence, R¹¹ is independently selected from the group consisting of —H and a counterion,
the repeating units are in a block, alternate, or random configuration, and each repeating unit is independently in the orientation shown or in the opposite orientation,
the polymer has a molecular weight of about 100,000 g/mol to about 20,000,000 g/mol, and
the polymer has about 30 wt % to about 50 wt % of the ethylene repeating unit comprising the —C(O)NH₂ group, about 5 wt % to about 15 wt % of the ethylene repeating unit comprising the —S(O)₂OR¹¹ group, and about 40 wt % to about 60 wt % of the ethylene repeating unit comprising the —N⁺R¹²₃X⁻ group;
about 0.0001 wt % to about 20 wt % of a surfactant that is at least one of a dodecyl sulfate salt and a cetyltrimethylammonium salt; and
about 50 wt % to about 99.999 wt % of a brine having a total dissolved solids level of about 100,000 ppm to about 500,000 ppm.
